(19) United States
(12) Patent Application Publication
(10) Pub. No.: US 2025/0245622 A1
(43) Pub. Date: Jul. 31, 2025

(54) SYSTEM AND METHOD OF OPERATING VEHICLE INVENTORY MANAGEMENT

(71) Applicant: Zyrka LLC, Framingham, MA (US)

(72) Inventors: Nathan David Vanshelboym ROTHSCHILD, Framingham, MA (US); Haoyang ZHOU, Boston, MA (US)

(73) Assignee: Zyrka LLC, Framingham, MA (US)

(21) Appl. No.: 19/030,454

(22) Filed: Jan. 17, 2025

Related U.S. Application Data
(60) Provisional application No. 63/626,175, filed on Jan. 29, 2024.

(51) Int. Cl. G06Q 10/087

(52) U.S. Cl. CPC G06Q 10/087

(57) ABSTRACT

A method of arranging two or more vehicles in a parking space includes scanning a first information tag attached to a first vehicle; transmitting the first unique identifier to a database; scanning a second information tag attached to a vehicle parking space; transmitting the second unique identifier to the database; scanning a third information tag attached to a second vehicle; transmitting the third unique identifier to the database; and arranging the second vehicle in the parking space so that the second vehicle blocks the first vehicle from leaving the parking space. The scanned first information tag corresponds to a first unique identifier and the scanned second information tag corresponds to a second unique identifier. The scanned third information tag corresponds to a third unique identifier.

### PRIORITY CLAIM

The present application claims the priority benefit of U.S. Provisional Patent Application No. 63/626,175, filed Jan. 29, 2024, the entirety of which is hereby incorporated by reference.

### BACKGROUND

The retail vehicle market is serviced by manufacturer-to-consumer and manufacturer-to-dealership-to-consumer sales and/or leases. To not be cut out of these purchase/leasing arrangements, vehicle dealerships need to manage costs and provide a satisfactory user experience. Vehicle dealerships are generally structured to take up large swaths of land to hold the full vehicle inventory. A lot with a central building and inventory spread over a large area presents a logistical problem for moving specific vehicles to and from points of interest, e.g., delivery to customers for the aforementioned sales and/or test drives. Furthermore, there may be additional lots, e.g., overflow lots, containing vehicles. Previous attempts at solutions have included clunky, expensive hardware or inelegant systems. Vehicle dealerships will need cost and time-efficient solutions to keep the market from shifting to a direct-to-consumer model.

### BRIEF DESCRIPTION OF THE DRAWINGS

FIGS. 1A-1E are a flowchart of an embodiment of a method for inventory management according to an embodiment.

FIG. 2 is a diagram of an embodiment of a system for adding a vehicle into the database.

FIG. 3 is a diagram of an embodiment of a system for checking in a vehicle to a parking space.

FIG. 4 is a diagram of an embodiment of a system for checking out a vehicle from a parking space for a test drive or otherwise moving the vehicle.

FIG. 5 is a flowchart of an embodiment of a system for checking out a vehicle from a parking space for a test drive or otherwise moving the vehicle.

FIG. 6 is a diagram of an embodiment for searching a vehicle dealership inventory for a vehicle.

FIG. 7 is a flowchart of an embodiment of a system for searching the vehicle dealership inventory for a vehicle.

FIGS. 8A-L are diagrams and flowcharts of embodiments for tracking, retrieving, and storing vehicles in parking spaces, in accordance with an embodiment.

FIG. 9 is an example illustration of an assessed lot with assigned parking spaces.

FIG. 10 is a high-level functional block diagram of a controller usable in conjunction with the system of FIGS. 1-9, in accordance with an embodiment.

### DETAILED DESCRIPTION

The following description is presented to enable one of ordinary skill in the art to make and use the invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

In an embodiment, the system operates with a combination of hardware and software to track and manage products, e.g., one or more vehicles, distributed over an area such as a parking lot or a warehouse. The system operates to provide a cost and time efficient solution to bringing products, e.g., one or more vehicles, to a customer. Each vehicle, key, and parking space includes an information tag, such as a QR code or other identification badge, that allows a handheld device to scan the tag and determine the vehicle, key, parking space, or other object with an information tag's status in a database. A first user is then able to modify, add, remove, or review any vehicle included in the database. As the database is changed, a second user is not hindered by the changes of the first user. Changes are made in real time and changes are made available as each change is recorded in the system. Because smartphones are ubiquitous among customers and employees, each user can seamlessly interface with the user interface to determine inventory and locate vehicles on the lot.

Software is downloadable to a smartphone to interface with the database and provide a display for a system user or customer to input selections. The software may run and be downloaded from an app store such as the Google Play Store, Apple App Store, or loaded directly to a handheld device. In at least one embodiment, the software is provided as a service via a website or other networked location which is accessible without requiring a software download. Alternatively, a handheld device may be a scanner with a display such as a Datalogic PowerScan PM9600 Industrial Cordless BarCode Scanner or the like.

The lifecycle of a vehicle add to the system may include setting up the database, adding users, adding vehicles, locating a vehicle, moving or otherwise modifying the status of a vehicle, and/or removing a vehicle from the system.

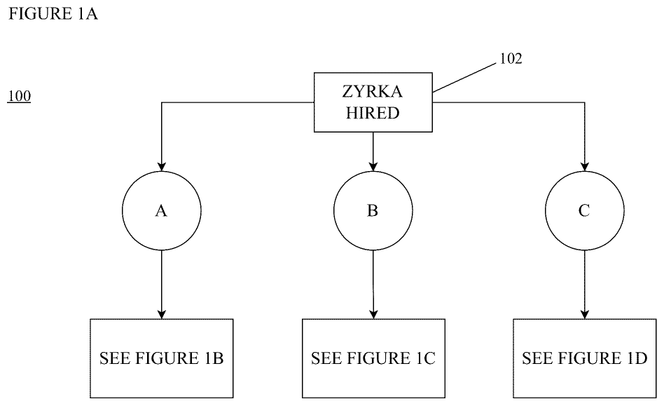

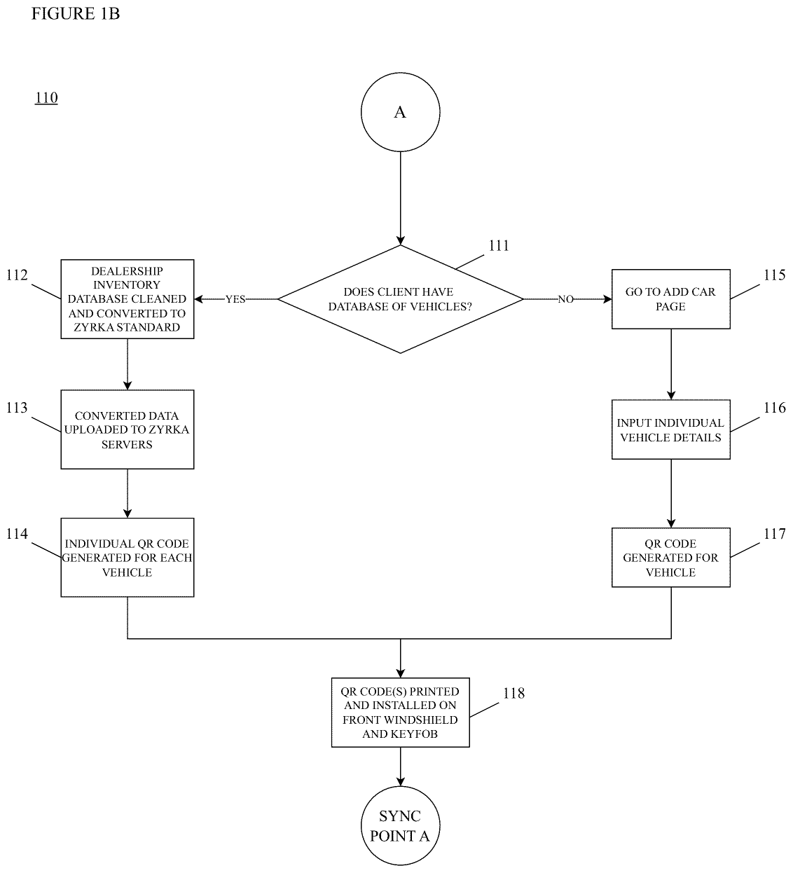

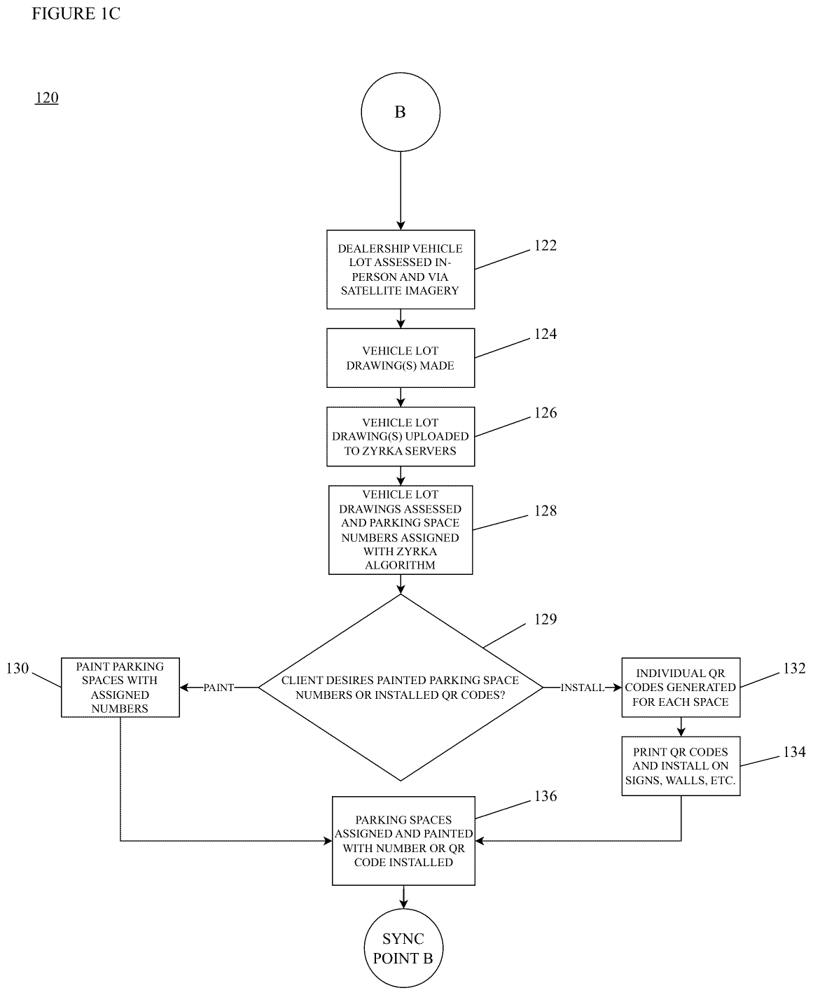

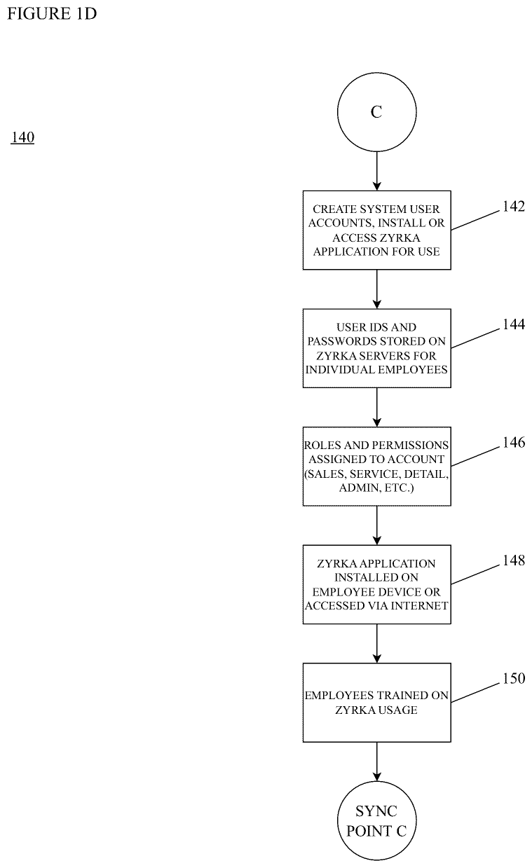

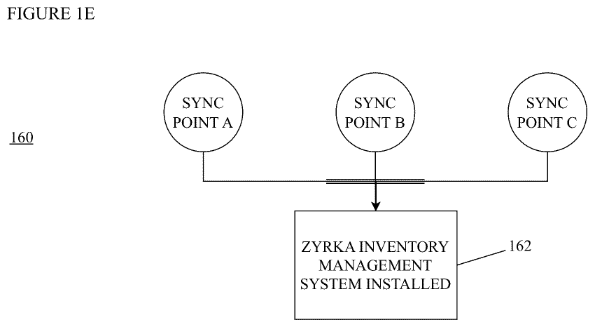

FIGS. 1A-1E depict an embodiment of a setup stage for the system. The area on which the vehicles are located, or “lot,” is surveyed to determine where vehicles may be placed. The lot may be in any shape or form and is often irregular to fit within property lines. A lot may be one contiguous space or divided into separate areas. In some embodiments, more than one database is used for one contiguous lot. In some embodiments, more than one database is used where a dealership wants to keep separate types of vehicles separated for accounting or other purposes.

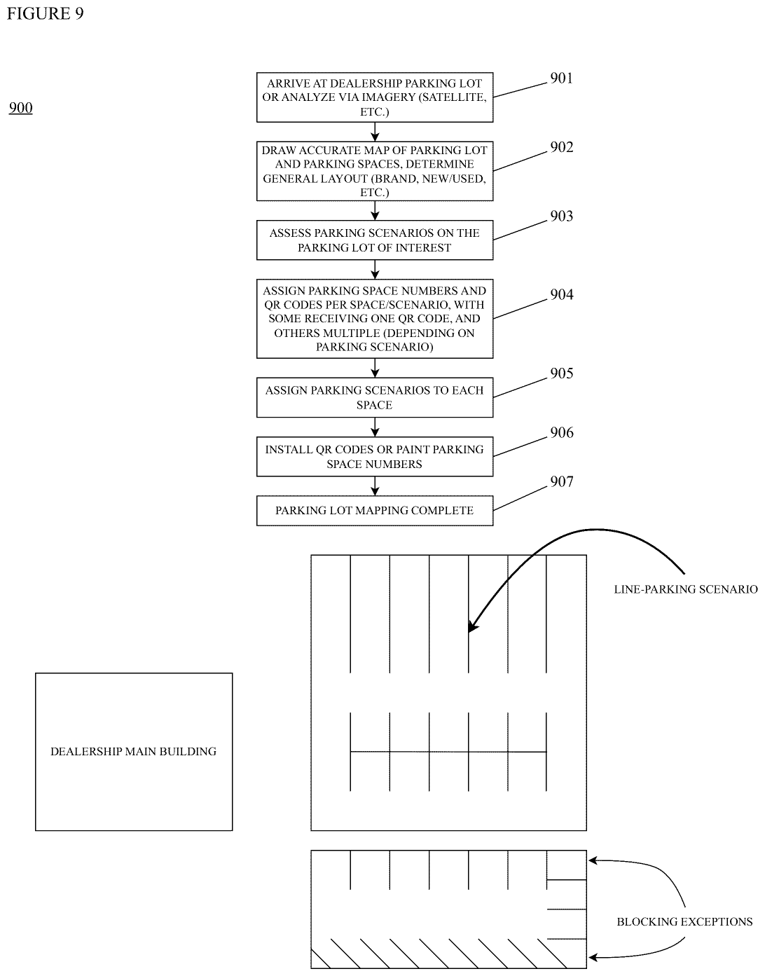

A map or picture of the lot is assessed to determine where parked vehicles may be stored. FIG. 9 depicts a lot divided into two distinct sections for mapping purposes. Parking spaces with numbers are assigned according to the parking lot assessment. Parking spaces may be any shape or size. Parking spaces may hold multiple vehicles. In some embodiments, each parking space is sized to accommodate more than one vehicle. Multiple shapes, orientations, and configurations of the spaces may be possible. In some embodiments, the assessment is performed by hand. In some embodiments, the assessment is performed by an algorithm which overlays parking spaces onto a map.

Information tags for the parking spaces (parking space information tags) are distributed after the parking spaces are assigned by assessment of the lot. An information tag, such as a QR code or other identification badge, is added to each parking space. If a space is sufficiently large, more than one information tag may be added. In some embodiments, one information tag represents multiple parking spaces. Information tags may be associated with a parking spot in any manner, including placement on a signpost, affixing on a wall, hanging above the space, or integrated into the ground at the parking space by painting, embedding, or the like. In at least some embodiments, the parking space information tags are attached to a surface, embedded into a surface, or carved into a surface. For example, the dots of a QR code may appear on a weatherproof sticker or may be drilled into a wall next to the space. The information tag may be a distance from the space occupiable by a vehicle. For example, a parking space information tag may be on a wall with a walkway between the parking space and the wall. There is no required distance so long as the tag is discernable as associated with the parking space.

Parking space information tags can be permanent or temporary. The parking space information tag may be mobile. For example, a parking space information tag may be fixed on a wall, or it may be placed on folding signage that may be moved around a lot as needed. The configuration of parking spaces may be changed at any time. In an alternative embodiment, the parking space information tags may be displayed on a display screen. The information on the display screen may be set or variable. In at least some embodiments, the information on the display screen is remotely controlled.

In FIG. 1D, users can be added or removed from the system as necessary. The system includes at least one admin account with higher permissions than other users, e.g., those with lower permissioned accounts (lower accounts). The admin accounts are responsible for managing the access of lower accounts, e.g., sales associate, service, and detail accounts, or the like. These lower accounts may have comparatively reduced permissions and may only be able to view, check in or out, add, or move vehicles. Customer accounts have the fewest permissions. Customer accounts may view the status or location of vehicles. The memory at the central server tracks and stores the associated data for all accounts of the system.

FIG. 1A is a portion 100 of a flowchart of a method for operating an inventory management system extending through FIGS. 1A-1E, in accordance with an embodiment.

In step 102, an inventory management system company is hired to set up an inventory management system according to one or more embodiments. The flow proceeds to one or more of paths A, B, or C and thus to the portions of FIG. 1B, 1C, or 1D, and then on to the completion in FIG. 1E.

FIG. 1B is a portion 110 of the flowchart of a method for operating an inventory management system, in accordance with an embodiment.

In determination step 111, a check is made to see if the client, e.g., dealership, has an existing database of vehicles. If the determination is positive, i.e., there is a database of vehicles available, the flow proceeds to step 112. In step 112, the dealership inventory database is cleaned and converted to a standard database for an inventory management system according to an embodiment. The flow then proceeds to step 113 wherein the converted data is uploaded to one or more servers. The flow then proceeds to step 114 wherein individual vehicle identifiers, e.g., QR codes, are generated for each vehicle. The flow then proceeds to step 118.

Returning to determination step 111, if the determination is negative, the flow proceeds to step 115. In step 115, a user manipulates a graphical user interface (GUI) of the system to transition to an add vehicle page. The flow proceeds to step 116 wherein the user enters individual vehicle details to the system. The flow proceeds to step 117 wherein a vehicle identifier, e.g., a QR code, is generated for each vehicle entered by the user. The flow then proceeds to step 118.

In step 118, the vehicle identifiers are printed and installed on the vehicle, e.g., on a windshield, and/or on a key or key fob. The flow then proceeds to sync point A in FIG. 1E.

FIG. 1C is a portion 120 of the flowchart of a method for operating an inventory management system, in accordance with an embodiment.

In step 122, the vehicle parking lot is assessed in-person and via satellite imagery. The flow then proceeds to step 124 wherein a drawing of the vehicle lot is created. In some embodiments, the drawing is automatically created based on imagery of the lot. In some embodiments, the drawing is manually created by a user.

The flow then proceeds to step 126 wherein the created drawing is uploaded to the server. The flow then proceeds to step 128 wherein the vehicle parking lot drawing is assessed and parking space numbers are assigned. The flow then proceeds to a determination step 129 wherein a decision is made by a client whether painted parking space numbers are used or parking space identifiers, e.g., QR codes, are used to uniquely identify the parking spaces.

If the decision is made to paint numbers on the parking spaces, the flow proceeds to step 130. In step 130, the parking spaces are painted with the assigned parking space numbers. The flow then proceeds to step 136.

Returning to determination step 129, if the decision is made to install parking space identifiers, the flow proceeds to step 132. In step 132, individual parking space identifiers are generated for each space. The flow proceeds to step 134 and the parking space identifiers are printed or otherwise displayed and installed on or near the parking spaces, e.g., on installed or existing signs/signposts, walls, or the like. The flow then proceeds to step 136. The flow then proceeds to sync point B in FIG. 1E.

FIG. 1D is a portion 140 of the flowchart of a method for operating an inventory management system, in accordance with an embodiment.

In step 142, system user accounts are created and installed or the inventory management application is accessed. The flow proceeds to step 144 wherein user identifiers (IDs) and passwords are stored on the server for individual users, e.g., dealership employees. The flow proceeds to step 146 wherein roles and permissions are assigned to accounts. The flow then proceeds to step 148 wherein the inventory management application is installed on devices or accessed via the internet. The flow proceeds to step 150 wherein the users are trained on the inventory management system usage. The flow then proceeds to sync point C in FIG. 1E.

FIG. 1E is a portion 160 of the flowchart of a method for operating an inventory management system, in accordance with an embodiment.

All three sync points, A, B, and C, come together in portion 160. In one or more embodiments, each of the paths from FIG. 1A to FIG. 1E are performed in parallel, to the extent possible. In one or more embodiments, each of the paths are performed serially.

In step 162, the inventory management system installation is complete.

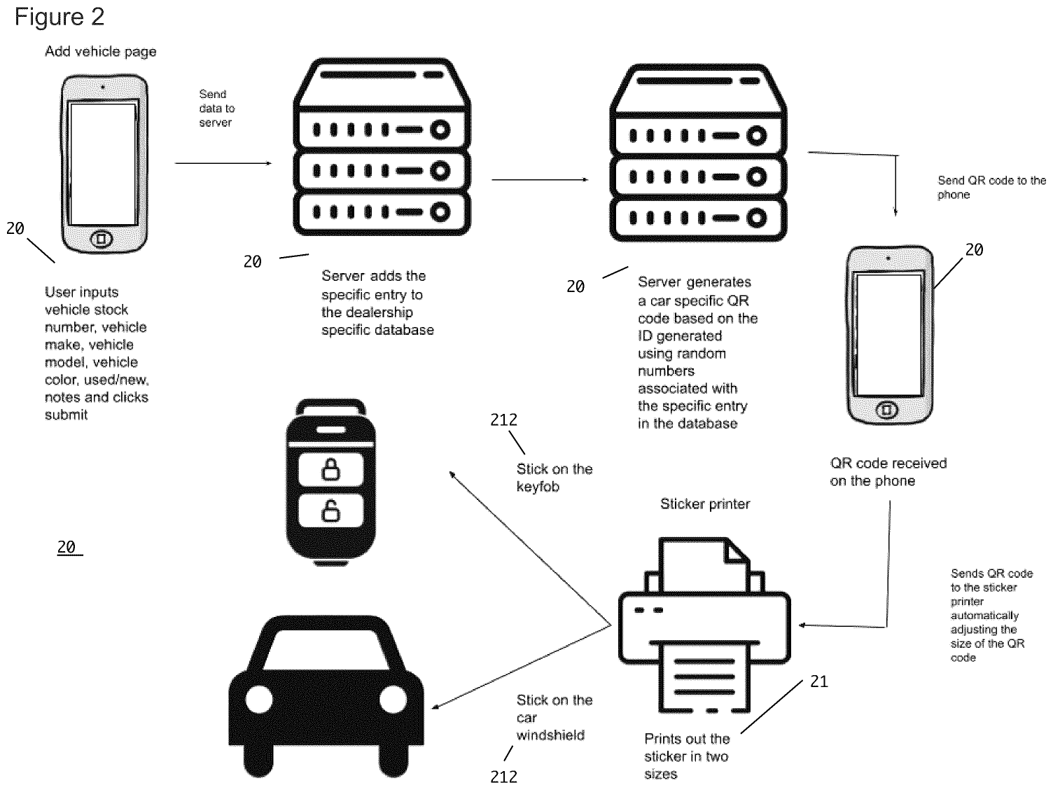

FIG. 2 is a diagram of a process flow 200 for a system user adding a vehicle into the database, in at least one embodiment. In order to establish a vehicle in the system, only one piece of unique information is required (e.g., a license plate or VIN number). In a preferred embodiment, more vehicle information relevant to the consumer such as make, model, color, or the like are included in the database. A vehicle may include one or more key fobs. Key fob information may be included with the vehicle information. The vehicle information can be text, pictures, or a combination thereof. During execution of process 202, the vehicle information is entered by a user having an account with permissions to add vehicles to the system into the handheld device or central terminal. The vehicle information is transmitted from the handheld device or central terminal to the central server where, in process 204, the server adds an entry to the dealership specific database. The added entry includes the transmitted vehicle information. The vehicle information may be entered by way of a graphical user interface.

In at least some embodiments, the handheld device can include a smartphone, tablet, or device with a screen and an optical scanner or the like. Central terminal includes laptops, computers, or stationary screens located in a showroom. In at least some embodiments, the central terminal includes a computer that remotely accesses the database.

The flow proceeds to execute process 206 wherein the central server generates a vehicle information tag for the vehicle in response to receiving information for the new vehicle. In at least some embodiments, the same vehicle information tag is usable for the key fob and vehicle. The flow then proceeds to execute process 208 where the central server transmits the vehicle information tag back to the handheld device or central terminal. The flow then proceeds to process 210 where the vehicle information tags are printed and affixed to the vehicle (process 212A) and/or key or key fob (process 212B).

In an alternative embodiment, the central server generates a second vehicle information tag for the one or more key fobs corresponding to a vehicle. In an alternative embodiment, the system does not require a separate vehicle information tag. The license plate, VIN number, or anything unique to a particular vehicle can be a vehicle information tag.

After adding a vehicle to a parking space, a system user or the system selects where a car should be parked. A user may do this by driving a vehicle around the lot and selecting an open space. In an alternative embodiment, the user may look at a map of open spots provided by the system or at a map with preset areas for certain makes and models of cars. The system may give the user a default parking space option along with a vehicle information tag. The system may assign a parking space based on one or more criteria. In at least one embodiment, the criteria include similarity of vehicle characteristics, need for maintenance, customer demand, difficulty of moving the vehicle, or the like.

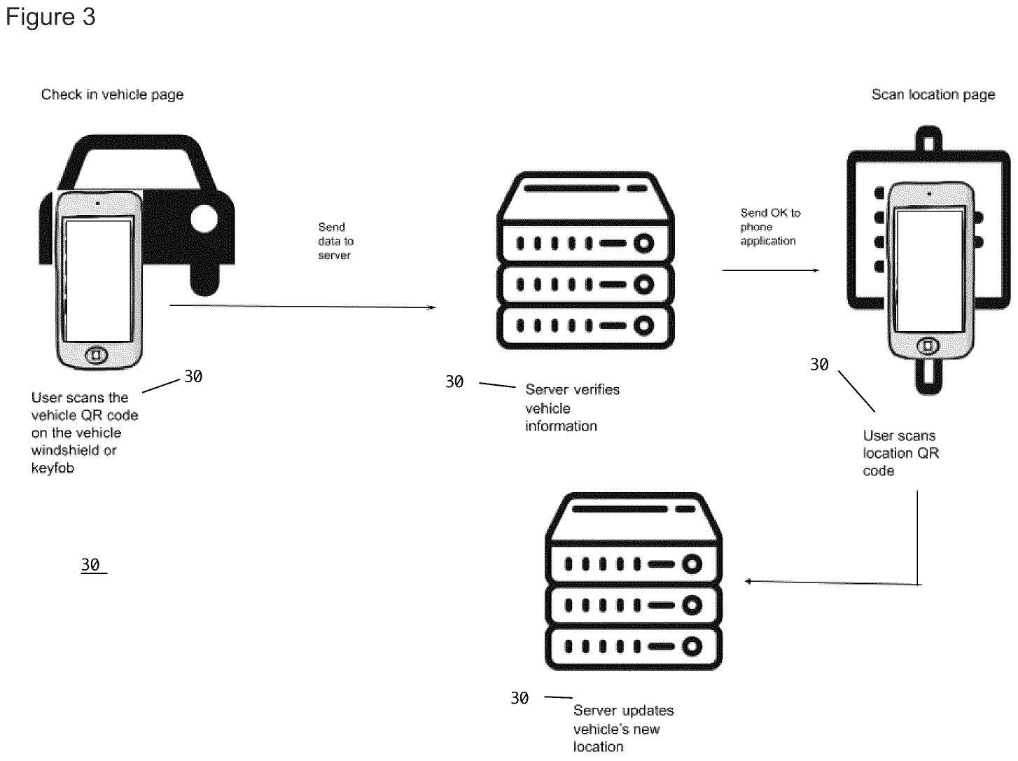

FIG. 3 is a diagram of a process flow 300 for checking a vehicle into a parking space. Once a user driving the vehicle has arrived at the parking space, vehicle check-in occurs beginning with process 302, where the user scans a vehicle information tag on the vehicle, e.g., affixed to the windshield or on a key fob. The scanned vehicle information is transmitted to the central server. The flow proceeds to process 304 wherein the central server receives the vehicle information tag for the vehicle in order to check in the vehicle. Confirmation of vehicle check in is provided to the user. The user then scans the parking space information tag on the parking space and the scanned information is transmitted to the central server. The flow proceeds to process 306 wherein the central server receives the parking space information tag for the parking space where the vehicle has been parked. The central server then establishes a link between the two database entries. This is accomplished by a linking engine. The linking engine comprises instructions stored in memory of the central server to create and store a link between one or more database entries. The linking engine function may be called to link any number of entries. A delinking engine function may be called to sever the connection between two entries. The linking engine may be performed by any known algorithm for connecting two data points in a database. For example, linking may be accomplished by memory manipulation in at least one embodiment. Memory manipulation may be most broadly categorized as changing sub data types, associated with a database entry, to change specific stored values. For example, a vehicle in a first position of a parking space may have a sub data type set to “0.” In at least one embodiment, a reference to one data point is stored in or related to another data point in the database. The system user may scan the vehicle information tag on the car with a handheld device. The system user may scan the parking space information tag at the parking space. The scanning steps may occur in any order. The unique value represented by each information tag, i.e., vehicle and/or parking space, is then transmitted to the database where, in process 308, the server updates the vehicle location. In at least one embodiment, the vehicle location is updated directly in the vehicle entry record. In at least one embodiment, the vehicle location is updated by changing a link between an entry for the vehicle and a parking space in the database. In at least one embodiment, confirmation of vehicle check-in only occurs after the central server receives both the vehicle information and parking space information.

According to an embodiment, a system user may need to move a vehicle from a first parking space to a second parking space. After the system user arrives at the second parking space, the system user scans the parking space information tag associated with the second parking space. The unique identifiers corresponding to the information tag for both the vehicle and parking space are passed to the central server. The central server updates the location information for the vehicle database entry. In an embodiment, one parking space holds one vehicle. In this base case, the location is changed after the central server updates the location information. In an alternative embodiment where multiple vehicles can be within one parking space or in an alternative embodiment where one parking space includes multiple sub-parking spaces in a cluster, a further bit of information is used to make the location change. The information transmitted from the handheld device to the central server may indicate where a vehicle is located within a parking space or the memory in the central server may be structured to determine the order. The additional information may be time-based, order-based, or a user may simply select an indicated sub-parking space from a menu or prompt. For example, when the parking spaces are assigned, a multi-spot space may include a prompt requesting the user to select to which sub-space the vehicle has been added. For example, in time-based operation, if a second car is added to a parking space that can hold multiple cars, the central server may rely on a time stamp to determine that the second vehicle arrived after the first vehicle. Because the parking spaces would be assigned based on the chronological order in which each would be occupied, the proper order would be ascertained by the central server. In the alternative, the central server may rely on the order the cars are checked in to determine vehicle arrangement. The data related to vehicle arrangement is held in the central server.

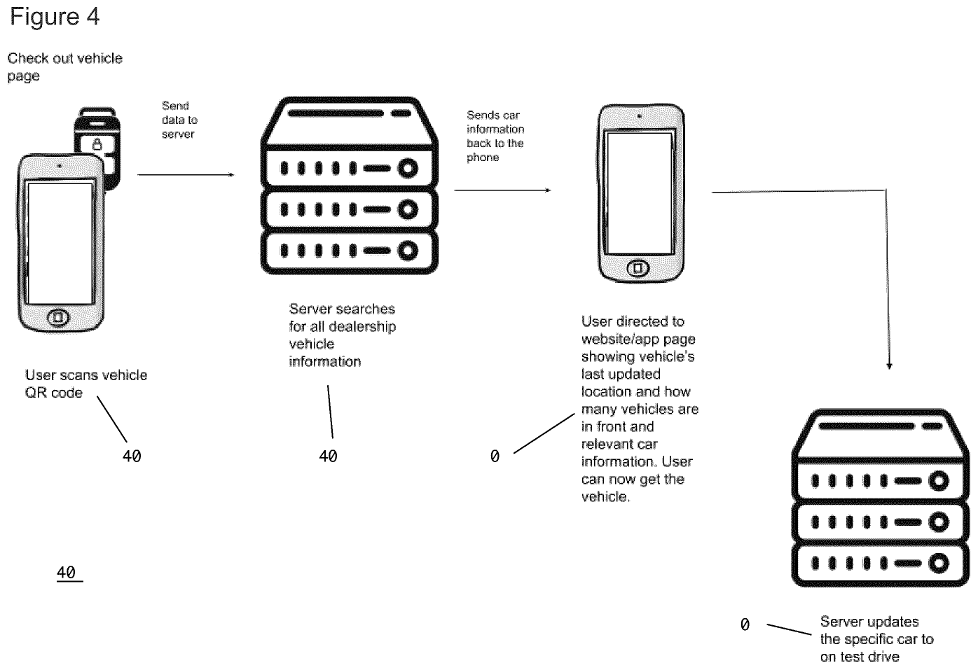

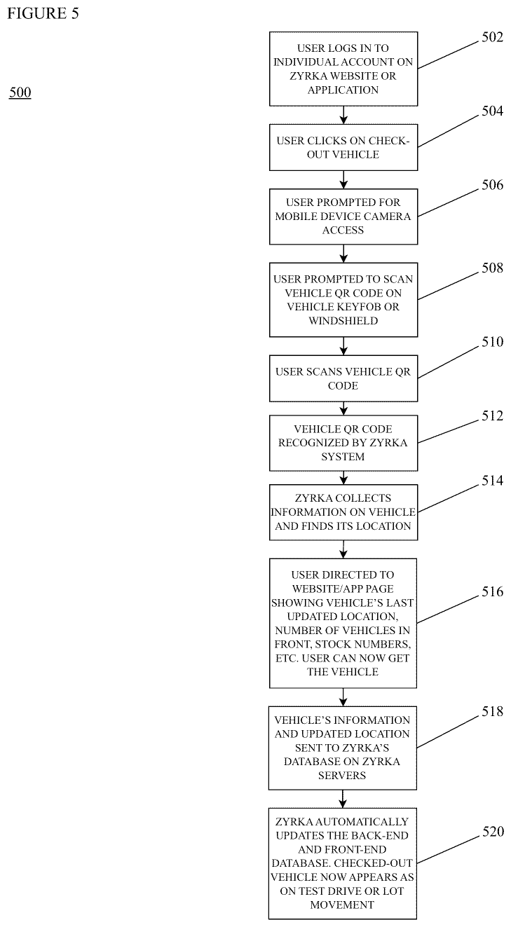

FIG. 4 is a diagram of a process flow 400 for the steps to check out a vehicle, in at least one embodiment. In FIG. 4 during execution of process 402, a handheld device is used to scan the vehicle information tag on a key fob. A key fob may be scanned where a sales associate knows that a key fob pertains to a certain vehicle a customer requested. Alternatively, other forms of storing keys may be used. The storage system may be complex; for example, a key tracking integrated hardware and software system. The storage system may be simple; for example, on a board with indicators or in labeled bins. The unique identifier the handheld device obtains by scanning the vehicle information tag on the key fob is transmitted to the central server. During execution of process 404, the central server searches for matching vehicle information in the dealership vehicle information database. The central server returns directions and map information to direct the system user to the vehicle in a parking space. During process 406, the user is directed to a website or app page displaying the vehicle's last updated location based on the parking space information linked to the vehicle information in the database. Additionally, information pertaining to how many vehicles are in front of the vehicle and other relevant vehicle information may be displayed. The process flows to process 408, and the central server updates the vehicle information entry to indicate that the vehicle is on a test drive or otherwise unavailable.

A request or a need to check out a vehicle may originate from a variety of different reasons. For example, a vehicle may need maintenance, a customer may want to look at a vehicle or test drive it, or several vehicles may need to be moved to access another vehicle. When a vehicle is needed, a system user or customer queries the system for vehicle information. Other embodiments included herein further set forth how the database is queried. Once the vehicle of interest is selected, a user is taken on an optimal path directly to the associated parking space. In the case where a customer finds a vehicle or the dealership needs a particular spot to be made available, a system user starts at the car. The vehicle information tag affixed to the vehicle allows the system to identify the corresponding parking space via the related parking space information and/or vice versa. The system user can update, by the handheld device, the location or status of the vehicle after scanning the vehicle information tag. In the alternative, in an instance where a handheld device is unable to scan an information tag, a user may enter information into the handheld device. For example, a user may enter a Vehicle Stock Number, Vehicle Identification Number, License Plate, or parking space number. A user may enter the information manually by typing, scanning, speaking, or otherwise entering the information into the handheld device. In at least some embodiments, a status update includes vehicle maintenance, a test drive, or the like. An update of the location of the vehicle may include proceeding to a different location and checking in the vehicle to a different parking space.

FIG. 5 is a flow chart of an example method 500 of checking out a vehicle. The system user may follow the steps to receive directions to a vehicle and to modify an aspect of the database entry for a particular vehicle. The system user begins the process at step 502 by logging into a handheld device. The system user navigates to a screen for checking out a vehicle in step 504. In some embodiments, the handheld device displays a graphical user interface that includes texts and/or images. For example, on a first page, the display may show a button with the text “Check-Out Vehicle.” Other similar text and/or images may be used to indicate to a system user the function of each page. By selecting the button, the system user may be taken to a second page, which prompts for camera access, if needed, in step 506. In some embodiments, the system user grants access every time a handheld device's camera is needed, or ongoing access may be granted. In step 508, the handheld device prompts the system user to scan a vehicle information tag on the vehicle. In at least one embodiment, the handheld device prompts the user to scan a vehicle information tag on a key or key fob. In at least one embodiment, a user manually inputs the vehicle information or parking space information, e.g., vehicle stock number or parking space number, if a camera is unavailable. Responsive to the system user scanning the vehicle information tag in step 510, the unique value represented by each vehicle information tag is then transmitted to the database managed by the system. Each vehicle in the parking lot has an entry in the database. In step 512, the central server matches the scanned vehicle information with an entry in the database corresponding to the vehicle. Because the vehicle information tag was scanned after navigating to the “Check-Out Vehicle” page, the handheld device transmits a status change that the vehicle is checked out. The database receives the unique value and the status change and updates the database entry associated with the scanned vehicle. In step 514, the central server determines the vehicle location from the database entry. In step 516, the user is directed to a website or app page showing the vehicle's last updated location, the number of vehicles in front of the vehicle, stock numbers relevant to the vehicle, and the like. In step 518, the central server updates the vehicle status and location information in the database. Because the database information is updated, other users that search the system database for the checked-out vehicle will see the dealership has the vehicle in stock and it is currently checked out. Depending on the particular user's permissions, further information may be displayed, such as which user has checked out the vehicle, whether the vehicle is on a test drive outside the dealership, or whether the vehicle is otherwise encumbered or the like. In step 520, the database information is backed up and the status of the vehicle is updated in the database. In at least some embodiments, the database information is manually backed up.

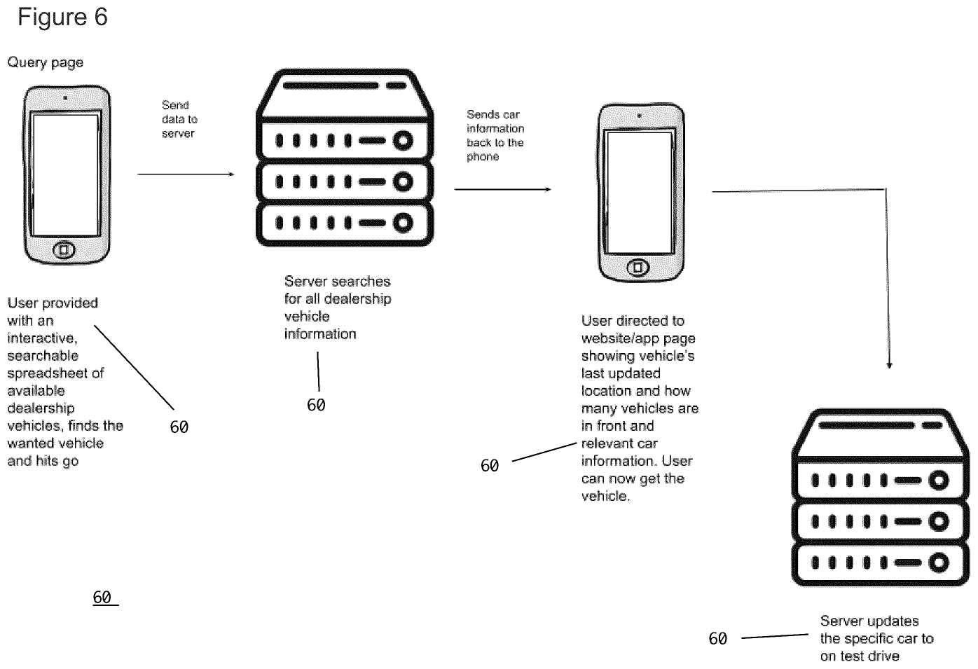

FIG. 6 is a diagram of a process flow 600 of an embodiment for searching the vehicle dealership inventory for a vehicle. When a customer wishes to look for a vehicle, the search is often based on attributes (e.g., make, model, color, price, features, or the like). The central server stores in memory each vehicle in the inventory in a similar structure. Only one piece of unique information about a vehicle is required for a database entry. However, the more relevant information added to an entry, the more useful the entry is to a person searching for a vehicle. A customer seeking to find a vehicle to purchase may review the inventory to select a suitable vehicle. A sales associate or other dealership employee may assist a customer or may search for a vehicle for internal purposes. A system user or customer may be presented with a graphical user interface. The graphical user interface may be accessed by a display. A system user or customer may access the inventory through the graphical user interface during execution of process 602. The options may be presented in a myriad of different ways. Non-limiting examples include spreadsheets, lists, checkboxes, drop-down menus, or the like. A customer may search by one or more particular features or filter by one or more particular features. The specific implementation and configuration of displaying the information in the database is not limiting so long as a customer could access all the publicly available inventory data of the dealership through the graphical user interface. Once a vehicle is selected, the central server searches for a matching vehicle or vehicles during execution of process 604 and may return location information, status, a list of any vehicles that block or restrict movement of the vehicle of interest, or any other relevant piece of information stored in memory. During execution of process 606, the user is directed to a website or app page displaying the vehicle's last updated location, how many vehicles are blocking the vehicle of interest, and other relevant vehicle information. Upon receipt of the information, a customer may request to test drive or purchase the vehicle. A customer may make a request for more than one vehicle. During execution of process 608, the central server updates the specific vehicle information entry to reflect the status of the vehicle.

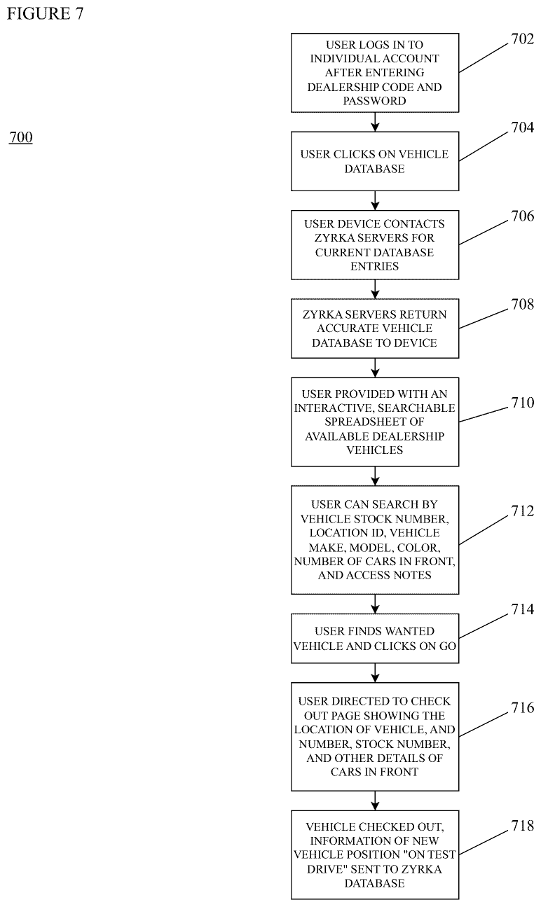

FIG. 7 is a flow chart of an example method 700 of querying a database to find a vehicle. During execution of process 702, the user begins the process by logging into a handheld device, central terminal, or any device that connects to the database of vehicle information stored in the system. During execution of process 704, the user manipulates the device to navigate to a screen for viewing the vehicle inventory information. During execution of process 706, the user device contacts the central server for current vehicle information for a particular dealership. During execution of process 708, the central server returns current vehicle information to the user device. During execution of process 710, the display shown by the device to the user may include a graphical user interface that includes text and/or images. For example, on a first page, the display may show a button with the text “Vehicle Inventory.” Other similar text and/or images may be used to indicate to a system user the function of each page. When the user selects the page for the inventory of vehicle information, the display provides an interactive, searchable spreadsheet of available dealership vehicles. During execution of process 712, the user can search by Vehicle Identification Number, Vehicle Stock Number, Location ID, Vehicle Make, Model, Color, number of Cars or Vehicles in Front, and/or access Notes or other additional stored data. After determining the vehicle or vehicles the user wants during execution of process 714, the user is directed to a check-out page during execution of process 716. See, for example, the vehicle check-out page included in the embodiment depicted in FIG. 5. During execution of process 718, the central server updates the vehicle information entry status in the database to indicate the vehicle is on a test drive.

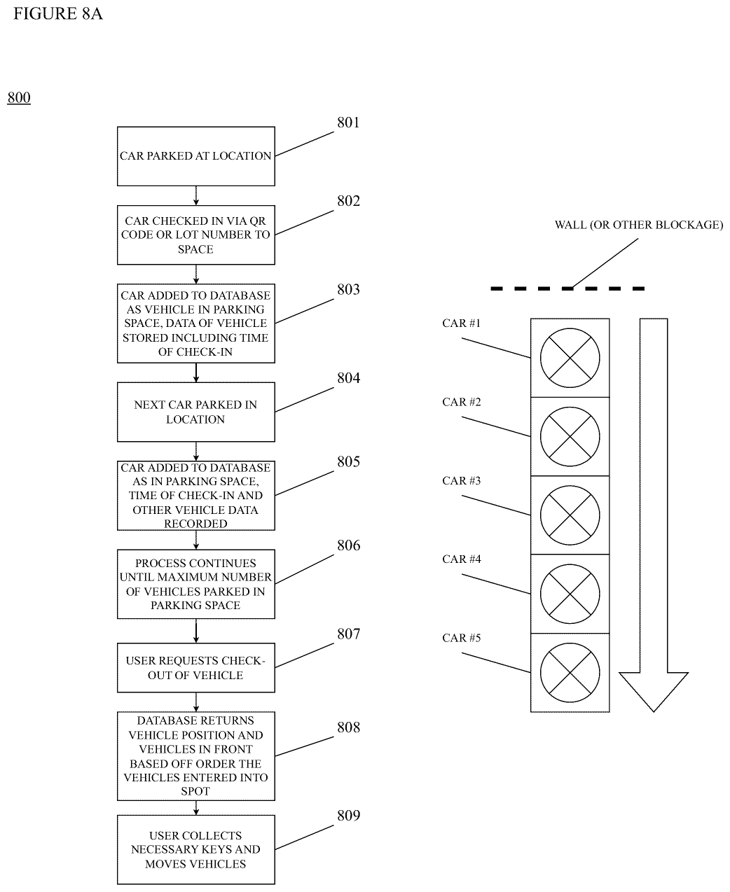

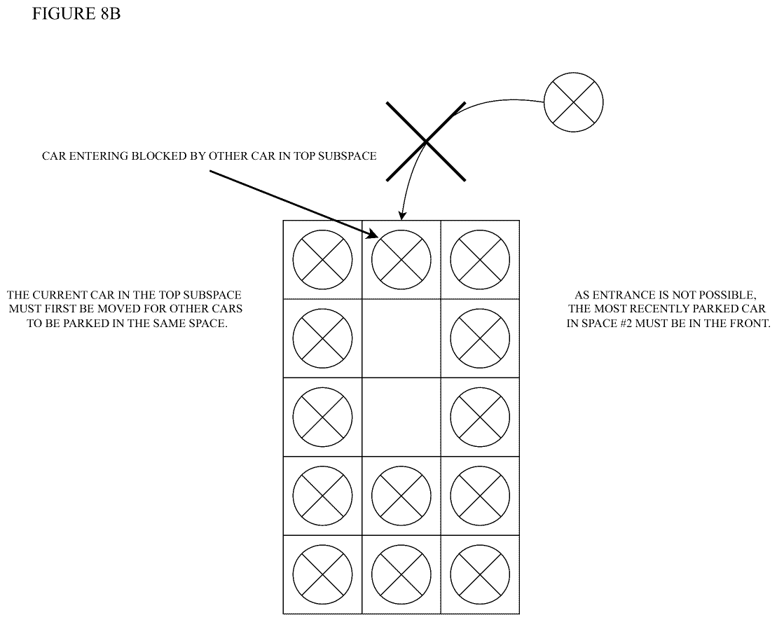

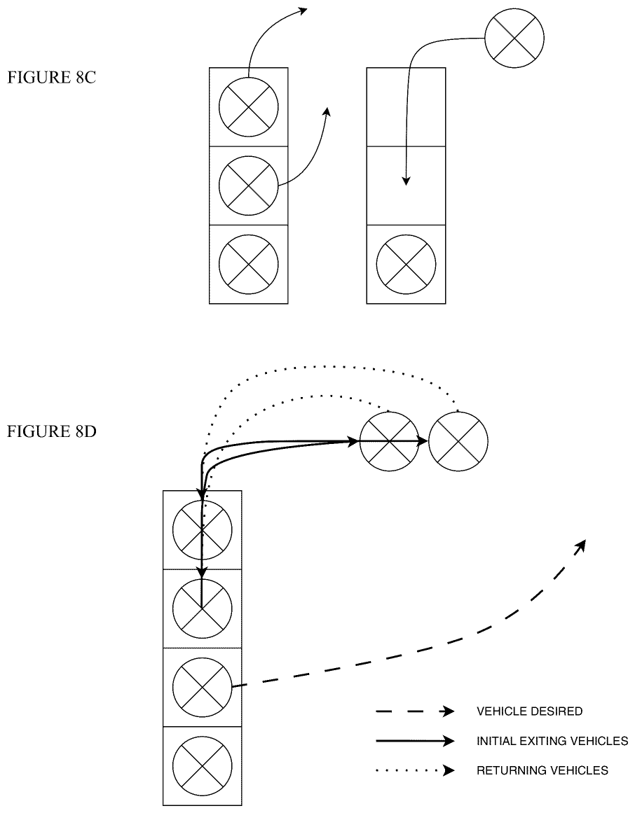

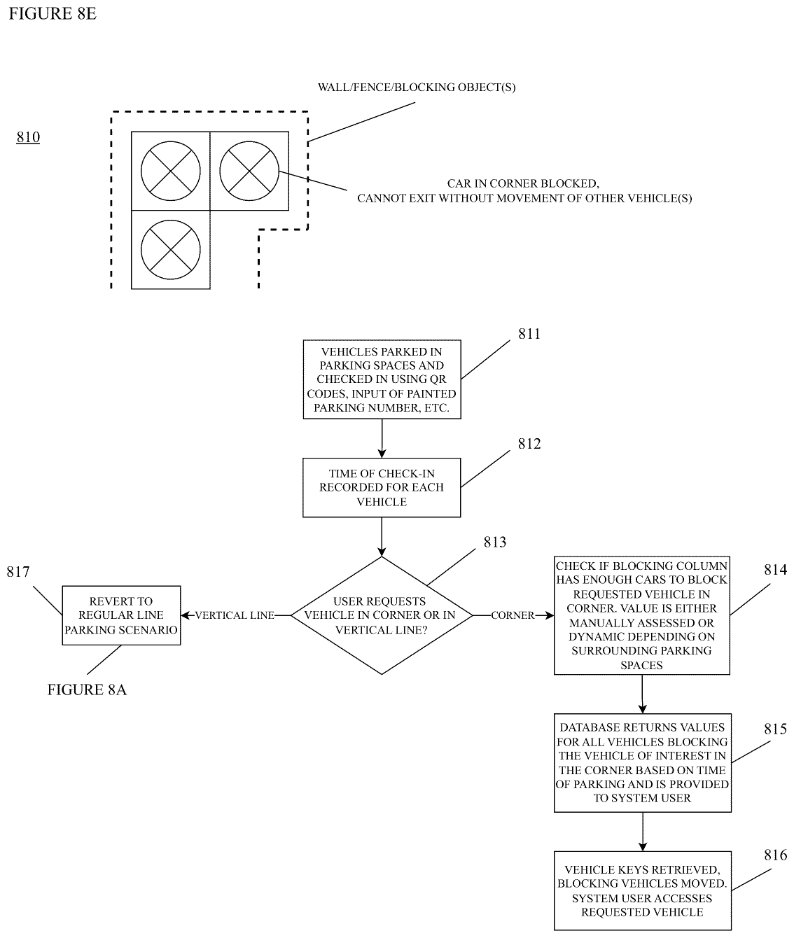

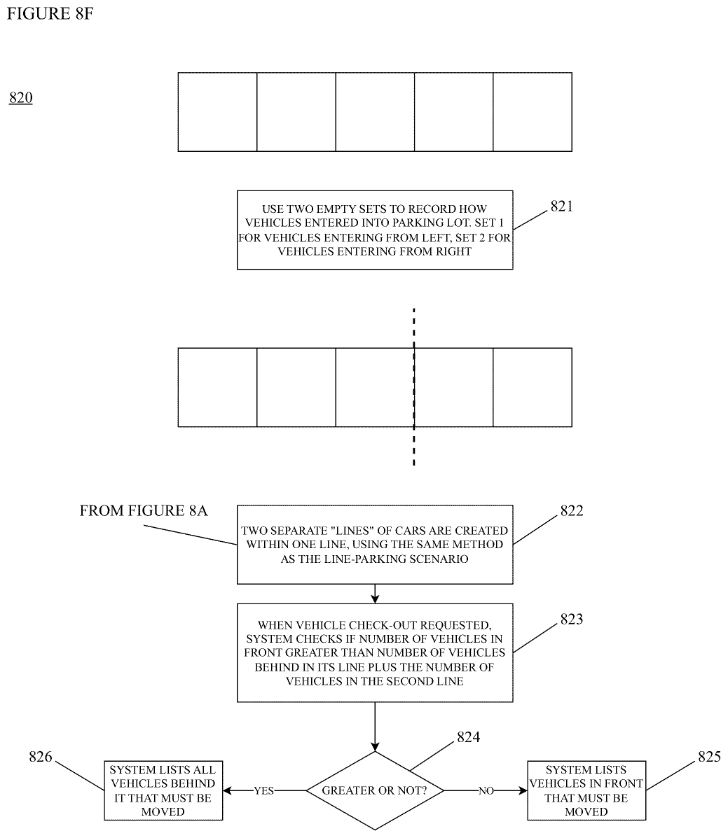

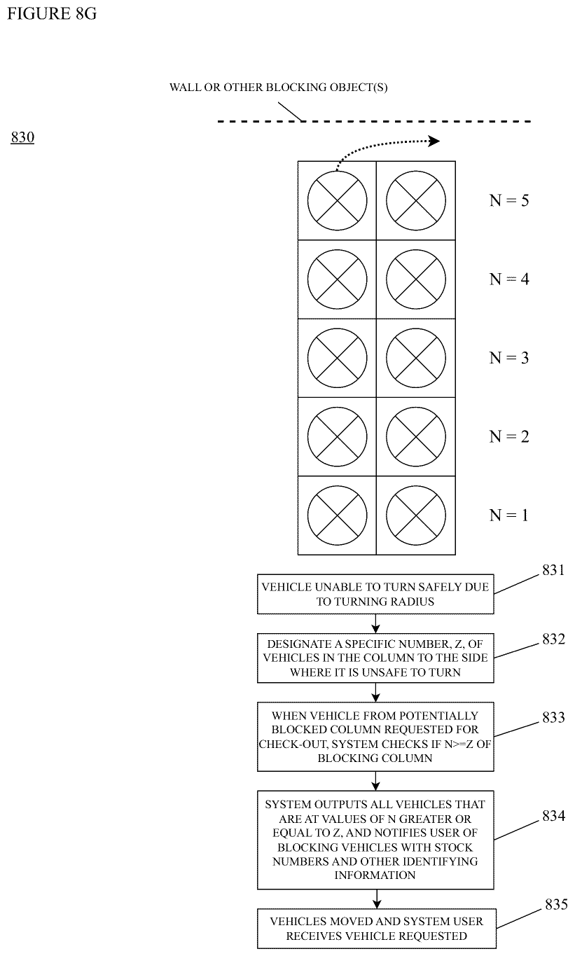

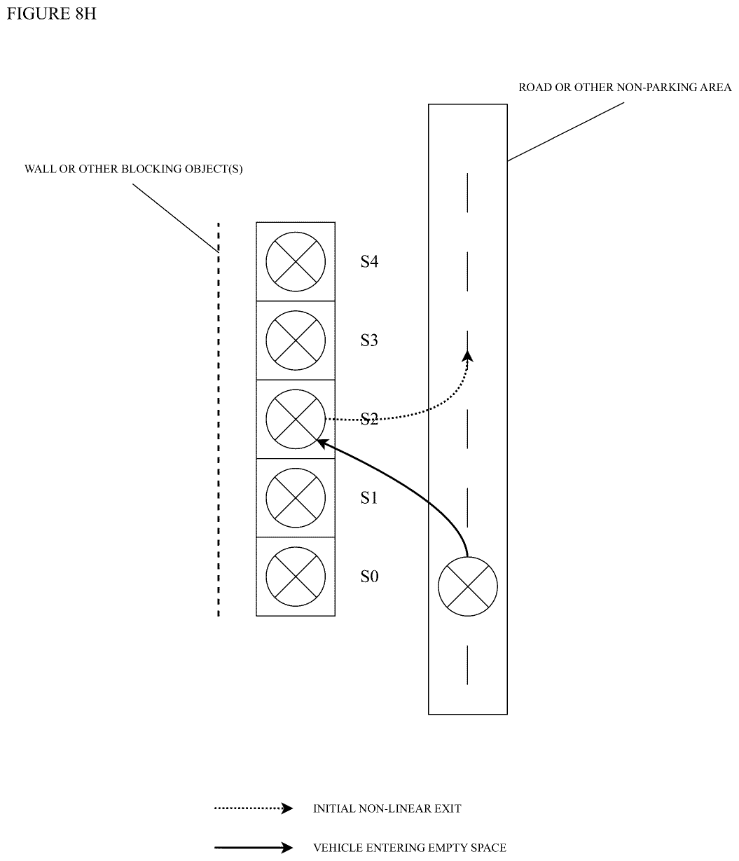

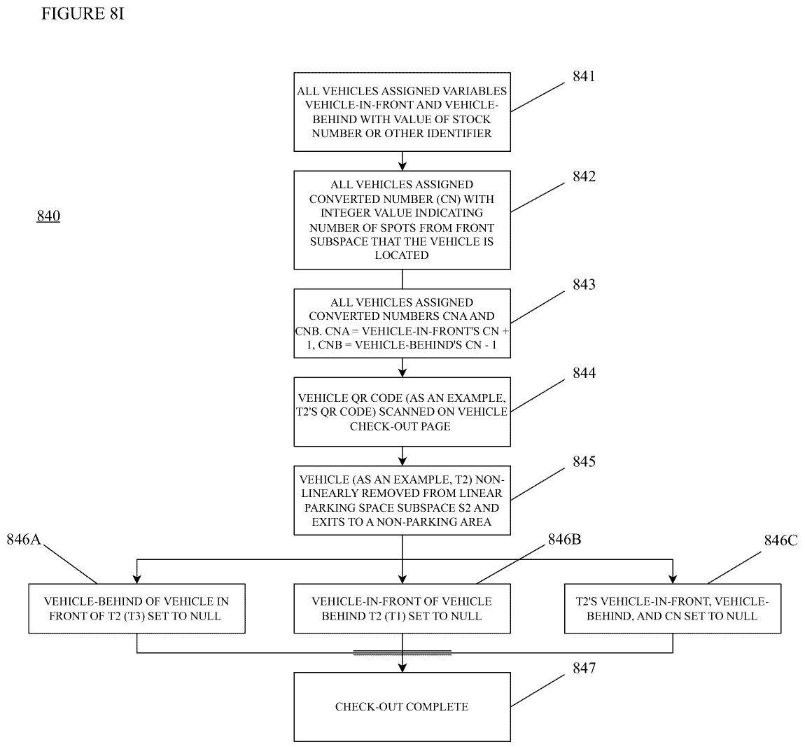

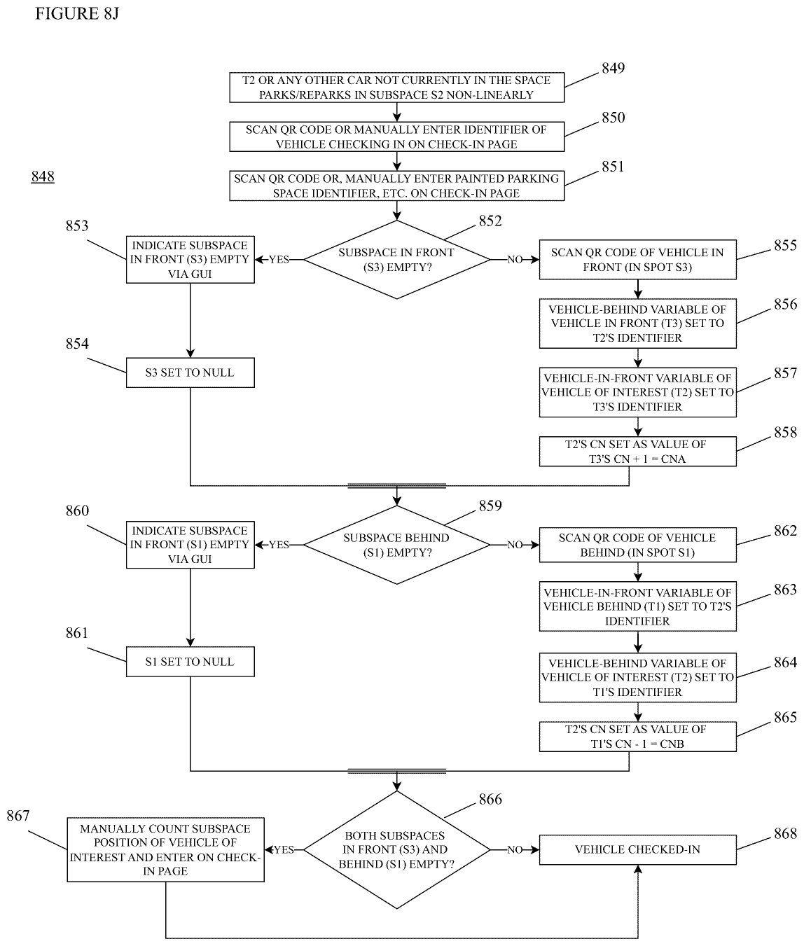

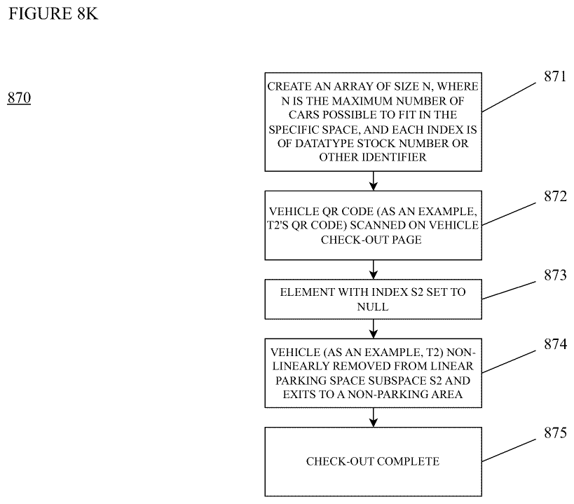

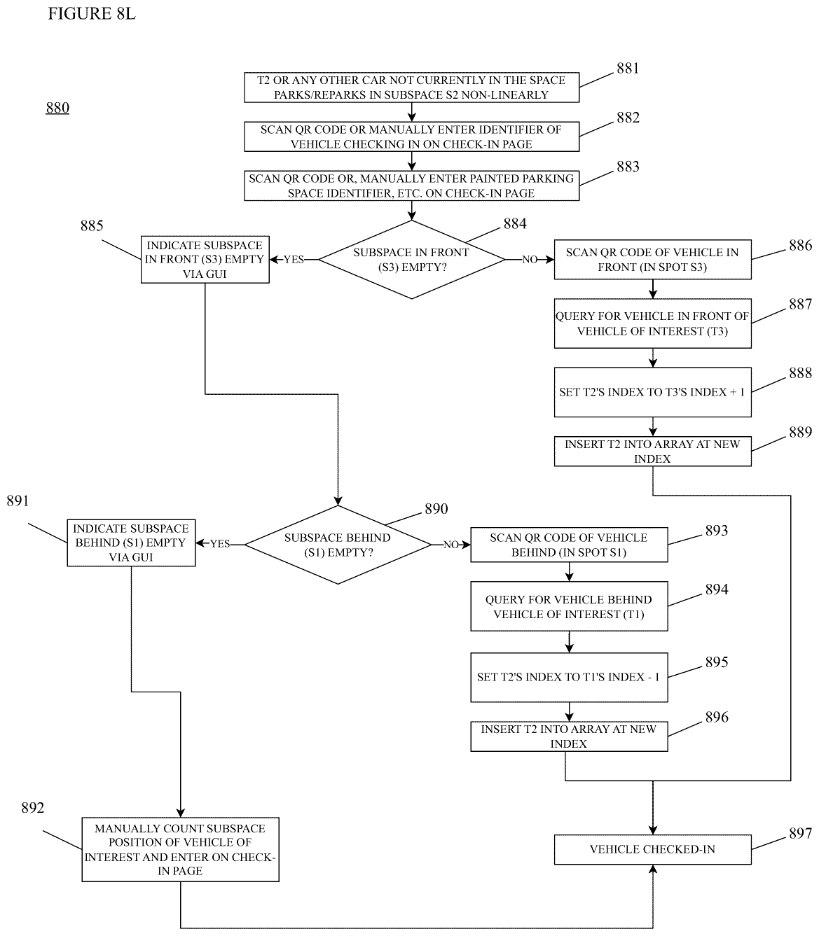

FIGS. 8A-L depict systems and methods for tracking, moving, and storing vehicles in irregular parking spaces. In some embodiments, where a vehicle of interest is included in a parking space, the central server can return location information for the keys associated with the vehicle of interest.

In some embodiments, vehicle key fobs are stored at key storage locations, e.g., on signs or in key tracking boxes such as a KeyTrack box. Some dealerships have multiple key storage locations, and it can be confusing and time-consuming to determine the location of the key fob. Similarly to how information about vehicles is stored and collected in this disclosure, keys are checked-in/checked-out to specific key storage locations, e.g., signs with hooks and key tracking boxes. This allows users of the dealerships to not only know the exact position of the car on the lot, but also the exact position of the key associated with that car. A step-by-step process for key fob check-in is as follows: 1. Select the key storage location the key is being placed, hung, or the like (or scan the QR code on the box). 2. A GUI displays the various positions for key placement. The position is either selected or the associated grid-square code is manually entered (e.g., column A, row 4). The key is now stored at that specific box in a specific location. The check-out process of a car using a key-fob tracking system is slightly different. In the above process, as described, the key fob is easy to access, and the QR code of the key fob is scanned to begin the vehicle check-out process. In another embodiment where it is more difficult to access the key fob, a system user selects a vehicle of interest from the spreadsheet or database, as described in FIG. 7. The user is then directed to a displayed page indicating the location of the key with regard to the specific key storage location, e.g., sign with hooks, key tracking box, or the like, and the specific location on or within the respective sign, box, or the like. Then, the vehicle check-out process continues as normal when the key fob is found by the user and directed to the page showing the location of the vehicle. In at least one embodiment, key location information is stored in the database and linked to the car using the aforementioned linking engine.

Where multiple vehicles are in a single parking space or multiple sub-spaces are in a parking space, the system may include a notification that multiple vehicles are present. In another embodiment, the central server would return a list of vehicles that block or restrict movement of the vehicle of interest. The list may include key fob information for each vehicle on the list. The central server returns the information for multiple vehicles so that a system user can move vehicles blocking other vehicles. Returning the list avoids the issue where a sales associate crosses a lot only to find the vehicle of interest is blocked from being moved, e.g., by other vehicles, physical objects, geographical phenomena, or the like. The sales associate would then have to return to the central building in order to find the key fobs for more vehicles. This may upset a customer that is left out alone or excessively waste time. By providing a way to link vehicles to parking spaces and providing a system user with all the vehicles at a parking space, time, money, and effort are saved.

In an example embodiment, three vehicles are parked in a corner of a lot so that only the lead vehicle can exit first, then only the middle vehicle. According to an embodiment, the central server would have an entry for the parking space and for each of the three vehicles, i.e., at least one entry for the parking space information and three entries for the vehicle information for the vehicles. Supposing a customer wanted to test drive the last vehicle, a sales associate may use a central terminal or a handheld device to select the vehicle. The system would return the vehicle information, including parking space location. The central server would also return the vehicle information for the lead and middle vehicle as each restricts the movement of the last vehicle. Alternatively, where a customer requests the middle car, the system would only return information for the middle and lead vehicle. The last car would not need to be returned since the last car does not restrict the movement of the middle or lead vehicles.

FIG. 8A is a flow chart of a process 800 for structuring and using vehicle entries to determine which vehicles need to be moved in order to free the vehicle of interest. FIG. 8A is also referred to as a general line parking scenario. FIG. 8A describes a stack or stack-like data structure for storing the cars in the system. The system would query the data and return the vehicle entries in a last-in, first-out methodology. The system would step through each entry until the system reaches the vehicle of interest. All vehicle entries the system steps through may be included in a list returned to the system user or customer who initiated the request. In step 801, a vehicle is parked in a location. In step 802, the vehicle is checked in as described above using a QR code corresponding to the parking space. In step 803, the central server adds the vehicle to the database and links the vehicle to the parking space. The vehicle data and time of check-in of the vehicle are recorded in the database. In step 804, a next vehicle is parked in the parking space. In step 805, the next vehicle is updated in the database and linked to the parking space. The vehicle data and time of vehicle check-in are recorded in the database. In step 806, the process repeats for one or more additional vehicles being added to the parking space, repeating steps 804 and 805 as needed. In step 807, a user requests to check out a vehicle. In step 808, the central server queries the database for the vehicle requested and returns the vehicle position as well as a list of vehicles in front of the vehicle requested based on the reverse order in which the vehicles entered the parking space. In step 809, the user collects keys for the corresponding vehicles, i.e., the requested vehicle and the vehicles in the returned list, and moves the vehicles to access the requested vehicle.

FIGS. 8C and 8D visually demonstrate the last-in, first-out methodology. As described herein, due to the return part of a recursion in the vehicle inventory management system, the easiest way to return vehicles is the same way they exit. As vehicles are removed, spaces free up, allowing new vehicles to be parked in those freed parking spaces. FIG. 8A arises in the scenario where an obstruction or combination of obstruction and vehicles restricts the movement of one or more vehicles in a parking space. FIG. 8A provides an efficient solution to free the restricted vehicles when needed.

FIG. 8B depicts an area with capacity for 15 vehicles. FIG. 8B is also referred to as a line parking scenario. As depicted in FIG. 8B and described herein, a vehicle cannot physically pass through an already-parked vehicle and therefore using timestamps is sufficient to know if a vehicle is blocking another vehicle. The area is subdivided into 3 parking spaces, each able to contain 5 vehicles. In FIG. 8B, the rectangular box is subdivided into 15 squares, each with an “X” or an empty box. An “X” is an occupied position. An empty box is an unoccupied position. The parking spaces are columns. The entrance/exit of the parking space is indicated by the arrow. Each column (left, center, and right) begins at the entrance/exit of the of the rectangle and proceeds along the long axis. A row is any three squares in the rectangle with a center line parallel to the short sides of the rectangle, and a column is any five squares in the rectangle with a center line parallel to the long sides of the rectangle. The first vehicle is placed into any of the columns and is moved to the furthest open row, i.e., farthest down the page. FIG. 8B is a diagram with two open spaces in the center column. The vehicle in the row nearest the entrance/exit of the center column would be moved to occupy the furthest open row from the entrance/exit.

FIG. 8E depicts a non-linear parking space. FIG. 8E is a diagram of parking spaces located against a wall in which the exit of vehicles is blocked from a side. FIG. 8E shows capacity for three vehicles (each denoted by an “X”). A wall, fence, vehicle, or other obstruction may require that each vehicle only enter or exit the parking space from the bottom side of the parking space. The underlying algorithm for the system in this arrangement is similar to a parent-child hierarchy using conjunction with recursion. The system is simplified by eliminating unnecessary branches via designating a starting point that is not the vehicle of interest and instead assigning a dynamic or manual value. The retrieval operation 810 for the configuration in FIG. 8E operates in the same manner as a linear configuration as seen or described herein. Each sub-parking space or vehicle within the parking space is added to a stack or similar data structure. When a customer or system user queries the data for a vehicle in the parking space, the system returns vehicle entries from the stack or similar data structure until the entry for the vehicle of interest is returned. All the vehicle entries the system stepped through may be included in a list returned to the system user or customer who initiated the request. The system can account for a parking space of any size, shape, or capacity by combining different parking space configurations.

In step 811, vehicles are parked in spots in the parking space and checked in using a QR code on the parking space marker or the like, as described above. In step 812, the time of check-in for each vehicle parked is recorded. In step 813, the system determines if the user requested a vehicle in a corner or in a line. If the user requests a vehicle in a line to exit, the flow proceeds to step 817, and the process proceeds as described above in connection with FIG. 8A. If the user requests a vehicle in a corner to exit, the flow proceeds to step 814, and a check is performed to determine if the blocking column has enough cars to block the requested vehicle in the corner. In some embodiments, the value is manually assessed. In some embodiments, the value is dynamic depending on the parking spaces surrounding the vehicle. In step 815, the central server queries the database to return vehicle information for vehicles blocking the requested corner vehicle based on time of parking. In step 816, the vehicle keys corresponding to the returned vehicle information are obtained, and vehicles are moved to access the requested corner vehicle.

According to an embodiment, a parking space may have more than one entrance and exit. FIG. 8F depicts a scenario 820 where space for five vehicles is configured into a line. FIG. 8F is also referred to as a two-exit scenario. In this scenario, a vehicle entering from the left can never be to the right of a vehicle entering from the right, and vice versa. For this reason, a dynamic system of two stacks is created with variable length from one initial stack. The position of the “middle” of the two stacks is unknown until the first vehicle is parked. After the first vehicle is parked, the lines operate as described in connection with FIG. 8A, with the caveat of determining which direction is easier to exit, i.e., fewer vehicles to move. The vehicles may only exit from either end, e.g., left and right ends of the space, and are unable to exit or enter from either long side, e.g., top or bottom of the space. During execution of step 821, the first vehicle parked in the line is placed in any spot and added to a first stack or stack-like data structure. A second stack or stack-like data structure is created after a second vehicle is added. The second vehicle is parked immediately adjacent to either side of the first vehicle. The divide between the first and second stack or stack-like data structure is represented by the elongated dashed vertical line in the lower box in FIG. 8F. The visual depiction is representative of the two data structures segmenting the vehicles into two groups. After the segmentation occurs, each group then has one entrance and exit. In FIG. 8F, the vehicles left of the elongated vertical line may be in a first stack or stack-like data structure and may only exit out of the left end. Conversely, the vehicles parked to the right of the elongated vertical line may be in a second stack or stack-like data structure and may only exit out of the right end. As indicated in step 822, two separate lines of vehicles are created within the single parking space. The process for adding and removing vehicles mimics the process for adding and removing vehicles in the single entrance, single exit linear scenario by dividing the line into two groups. The subdivision may be entered manually into a computer or carried by instructions stored in memory. Further divisions may be made to accommodate more entrances and exits.

In at least one embodiment, in response to a situation in which a single vehicle remains, no merger occurs. One stack will be left empty (or deleted), while the other will retain the vehicle. This assumes a greedy algorithm as with other scenarios. The parking space is treated as two separate lines of vehicles within the single parking space, but can dynamically become one (if the other is empty, meaning it will be deleted). In at least one embodiment, the algorithm does not check both stacks. It only checks the current stack as the algorithm ensures that the current stack is the most optimal solution for the current car (hence the dynamic nature of the stacks, as the dividing line is moved to ensure an optimal stack).

There is no overlap between the two stacks.

If the parking space is filled with 5 vehicles, and the middle vehicle is desired, the middle vehicle is part of one of the two unevenly split (“greedy”) stacks. That stack is the direction of exit, and hence requires the removal of that stack's vehicles in front.

The greedy stack is determined by the order of vehicles entered. The stack that currently has the “oldest” vehicle entered is given priority for the possession of the most vehicles (i.e., is given “greediness”) over the other stack, ensuring that the middle vehicle is only possessed by one stack. The priority remains with the stack until the removal of vehicles causes a deletion event, leading to a one-stack system. Then, the priority system is reset to start again as normal.

FIG. 8F represents a dynamic data structure where the size of data is not known until at least one vehicle is parked in a parking space. The central server then creates the stack or stack-like data structure after receiving the unique identifier for the first car to be parked in the parking space. A combination of static and dynamic length stack or stack-like structures may be used depending on the particular configuration of the parking space.

In step 823, responsive to a vehicle check-out request, the central server determines if the number of vehicles in front is greater than the number of vehicles behind the requested vehicle in the particular separated line of the sub parking space of the vehicle, plus the number of vehicles in the second line, i.e., the other particular separated line of the sub parking space with vehicles. The flow proceeds to step 824, and the system determines if the number of vehicles in front is greater than the number of vehicles behind.

If the number of vehicles is not greater, step 825 is executed and the system generates a list of the vehicles in front of the requested vehicle that must be moved. If the number of vehicles is greater, step 826 is executed, and the system generates a list of the vehicles behind the requested vehicle that must be moved.

FIG. 8G depicts vehicles in columns and rows. FIG. 8G is a scenario wherein vehicles are blocked to the side by other vehicles. The vehicles are represented by an “X” in each box. The area is subdivided into two parking spaces: a left column and a right column. In FIG. 8G, the vehicles are obstructed on the left, right, and bottom sides. In at least one embodiment, the vehicles in FIG. 8G are completely obstructed from leaving the parking space via the left, right, and bottom sides. The vehicle of interest in this scenario is left column n=3. The cars are ordered in two stacks or stack-like data structures-a first stack for the left column and a second stack for the right column. The exit/entrance has an additional restriction: one or more of the vehicles in the left column cannot turn past the right column to completely exit. In this example, not all vehicles in the left column must have this restriction, but at least one between the vehicle of interest (left column n=3 position) and the lead vehicle, inclusive, must have the restriction. The exit/entrance path is indicated by the arrow from the left column n=5 position. The vehicle in the right column n=5 position must be removed before all the vehicles in the left column are free to exit or enter. The central server would return vehicle information for the vehicle of interest (left column n=3 position) and for the obstructing vehicles (left column n=4, left column n=5, and right column n=5) when a system user or customer queries the central server, by handheld device or central terminal, for the vehicle of interest. The system user would then gather the keys, follow the directions to the parking space, and move the appropriate vehicles.

The central server would start by stepping through the first stack until the central server reached the vehicle of interest. The first stack and second stack would be linked with the additional requirement that the left and right columns may provide exit or entrance restrictions. The linkage would be added as optional when the lot map was first assessed and assigned parking spaces. As a system user would place vehicles into the configuration of FIG. 8G, the central server would ascertain the order. The central server determination may be time-based, order-based, or a user may simply select an order from a menu or prompt. FIG. 8G includes steps of a process 830. In step 831, a vehicle is determined to be unable to turn due to a tight turning radius being limited by the presence of a vehicle in an adjacent column. In step 832, a specific number of vehicles in the adjacent column where the turn is unsafe is designated. In step 833, responsive to a request for a vehicle from a potentially blocked column, the system determines if the number of the vehicles in the adjacent column is greater than or equal to the designated specific number of vehicles in the adjacent column that makes turning unsafe. If the number is greater than or equal to the designated specific number, the system generates a list of all vehicles that are at position values greater than or equal to the designated specific number and generates a notification to the user of the blocking vehicles with the vehicles' information in step 834. In step 835, the vehicles are moved, and the requested vehicle is available.

FIG. 8H is an illustration of a line of parked vehicles, and the operations 840, 848, 870, and/or 880 of the system in an alternate embodiment are described. FIG. 8H is also referred to as a non-linear vehicle movement and parking embodiment. The system may step through a stack or stack-like data structure of vehicle entries in a last-in, first-out method. In the alternative, as depicted in FIG. 8H, the system may use a first-in, first-out step-through method. In FIG. 8H, the line of vehicles is linear, and the movement is restricted to an exit at the top end and an entrance at the bottom end. In an embodiment, vehicles may be removed from a long side of the line of vehicles. The lead position is S4. The last position is S0.

After assessing a lot map and assigning a parking space, a first vehicle is placed into the lead position. The first vehicle transits through the entrance and all the spaces (S3-S0) to park in the last space, S0. Subsequent vehicles are parked in spaces S1 to S4. The central server would return vehicle information for the vehicle of interest, for example, the T2 vehicle, and for the obstructing vehicles T3 and T4 when a system user or customer queries the central server by handheld device or central terminal for the vehicle of interest. In one embodiment, the vehicles are then returned to the original spaces when the vehicle of interest is returned.

FIG. 8H is an illustration of a line of vehicles that may operate in the last-in, first-out method as described above. In addition, a central vehicle, for example, a vehicle in the S2 position, can be removed from the parking space without moving another vehicle in the 5-vehicle stack. If the vehicle in the S2 position is moved carefully between the T1 and T3 vehicles, it may be removed from the line without moving or adjusting the position of the remaining vehicles. This may be accomplished by a multi-point vehicle turn or by other mechanisms, including vehicle dollies, forklifts, or the like. When a system user wants to check out a vehicle in the center of a stack for a test drive, an advantage is gained by not having to move other vehicles. In time-based operation, where vehicle position in the parking space is determined by the time an information tag is scanned, returning a central vehicle would improperly alter the vehicle order in the database. In some embodiments, to ensure that the order of vehicles will remain the same algorithmically, the system will create a temporary value in the database that has the same converted number as the vehicle that exited position S2. A converted number can be defined as a parking space or a sub-parking space that designates the location of a car in a parking space. A converted number can be sufficiently large to accommodate any size parking space. One example of assigning converted numbers (CN) is given by Equation A where the maximum number of cars possible to fit in the spot (MAX #), current number of cars in the spot (CNC), and cars in front of the vehicle of importance (INFRONT). Equation A: CN=MAX#−CNC+INFRONT+1.

The temporary value will keep the vehicles that have not moved physically from S1 or S3 in their respective positions. The system does not “reset” or change any of the other converted numbers. In one embodiment, when the vehicle is returned back to the S2 position, the system user is prompted to rescan all the vehicles in the parking space to confirm the vehicle order is correct. The prompt may direct the system user to a check-in/check-out or direct the system user to a specific page with one or more graphics instructing the system user to rectify the order. For example, the page may be titled “Quick Fix.”

In an embodiment, there are 5 vehicles in a column with the ability to exit via both the regular line-parking scenario and “European parking,” or a non-linear vehicle movement, to squeeze directly out to the right or left via multi-point turn or forklift. In such a situation, no vehicle is “completely blocked” by any other vehicle. Attempting European parking is often unsafe and more difficult than exiting in the previously described standard linear manner. If a system user attempts European parking without the below addition, it could induce the algorithm to provide false information if the subspace number is not preserved algorithmically for the vehicle. This is because the regular line parking case assumes that the order of entrance and exit will always remain the same due to blockage. The methods below assume that scanning the vehicle in front and scanning the vehicle behind is less mistake-prone and more efficient than counting from a designated end, though they will each achieve the same purpose. In an embodiment, this is achieved via a doubly-linked list or, in another embodiment, via array indexing. Both methods are detailed below with respect to FIGS. 8I-8L, along with one or more advantages and/or disadvantages of one or more embodiments.

“European parking”, or non-linear vehicle movement and parking, is referred to as a line of multiple vehicles that would regularly exit linearly to the front, back, or have two-exits (both front and back), but also has one or more sides that can exit to a non-parking area (i.e. a road, a place to move vehicles around the lot that is not specifically designated as parking, a place on the lot that does not regularly park vehicles, or the like).

Algorithm (doubly-linked list): For each vehicle (of any parking type, regular or European) the identifiers of the vehicle in front of the vehicle of interest and the vehicle behind the vehicle of interest are stored. In an embodiment, these are referred to as variables “vehicle-in-front” and “vehicle-behind”. These vehicles have a stock number of the vehicle-in-front and the vehicle-behind as their value. Furthermore, a CN (converted number) needs to be stored, indicating the number of spots from the front subspace the vehicle is located. Let T0, T1, T2, T3, and T4 be the vehicles in spaces S0, S1, S2, S3, and S4. If the vehicle of interest is the back vehicle in position S0, the “vehicle-behind” is null, with the CN set to the maximum number of vehicles possible in the spot. In this embodiment, the linked list goes from front to back. In another embodiment, the linked list goes from back to front. If it is the front vehicle, T4, the “vehicle-in-front” is null with the CN set to 0.

FIG. 8I is a flowchart of a method 840 of checking out a vehicle using a doubly-linked list according to an embodiment. FIG. 8I assumes that there are vehicles, i.e., T0-T4, parked in subspaces, i.e., S0-S4, of a linear parking space. In a given example, T2 is non-linearly removed from subspace S2 and exits to a non-parking area. As described above, method 840 begins at step 841 wherein the system assigns vehicles to variables vehicle-in-front and vehicle-behind based on vehicle information. The flow proceeds to step 842 wherein all vehicles in the parking line are assigned a converted number with an integer value indicating the number of spots from the front subspace the vehicle is located. The flow then proceeds to step 843 wherein the system assigns converted numbers CNA and CNB to vehicles. CNA corresponds to the vehicle-in-front's converted number+1, and CNB corresponds to the vehicle-behind's converted number−1. The flow proceeds to step 844 wherein the QR code of a vehicle to be removed from the parking line, e.g., T2, is scanned or otherwise entered into the system to thereby indicate the vehicle is being removed from the parking line. The flow proceeds to step 845 wherein the scanned vehicle is removed from the linear parking space subspace, e.g., S2, and exits the parking area. Assuming vehicle T2 leaves via European parking out of space S2, T2's QR code is scanned, and T2 is checked out as usual without the user first checking out the vehicles blocking T2 (T3 and T4). In at least one embodiment, the process flows to steps 846A, 846B, and 846C in parallel wherein the vehicle in front of T2 (T3's) vehicle-behind variable is set to null (step 846A), the vehicle behind T2 (T1's) vehicle-in-front is set to null (step 846B), and T2's vehicle-in-front, vehicle-behind, and CN are set to null (step 846C).

FIG. 8J is a flowchart of a method 848 of checking in a vehicle using a doubly-linked list according to an embodiment. Similar to FIG. 8I, FIG. 8J assumes that there are vehicles, i.e., T0-T4, parked in subspaces, i.e., S0-S4, of a linear parking space. In a given example, T2 is non-linearly removed from subspace S2 and exits to a non-parking area. Method 848 begins at step 849 when T2 or any other vehicle enters/reparks/is forklifted in (check-in process). The flow proceeds to steps 850 and 851 wherein a user scans the QR code of the space and the QR code of the vehicle being checked in. If, in step 852, the user determines that the subspace in front, i.e., subspace S3, is empty, the flow proceeds to step 853 wherein the user indicates that the subspace in front is empty via the GUI and the flow proceeds to step 854 wherein the system sets parking space S3 to null. Returning to step 852, if the subspace is not empty, the QR code of the car directly parked in front, T3, is scanned by the user in step 855. In step 856, the vehicle-behind variable of the vehicle in front is set to vehicle T2's identifier and the flow proceeds to step 857 wherein the vehicle-in-front variable of the vehicle of interest T2 is set to vehicle T3's identifier. In step 858, the vehicle T2's CN is set as the value of vehicle T3's CN+1 corresponding to CNA. The flow then proceeds to step 859 wherein the user determines whether the subspace behind parking space S1 is empty.

Similar to steps 853 and 854, if the subspace is empty, the flow proceeds to step 860 wherein the user indicates that the subspace behind, i.e., subspace S1, is empty via the GUI and the flow proceeds to step 861 wherein the system sets parking space S1 to null. Returning to step 859, if the subspace is not empty, the QR code of the vehicle behind, i.e., the vehicle in space S1, is scanned. Upon scanning the QR code of the vehicle behind, the vehicle that is behind the vehicle of interest, T1, changes its value of “vehicle-in-front” to the vehicle of interest, T2, in step 863. Then, in step 864, the vehicle of interest, T2, sets the value of “vehicle-behind” to the vehicle behind, T1. Furthermore, in step 865, the system assigns a CN of the vehicle of interest, T2, to the value of the vehicle-in-front (T3)'s CN, −1. The assigned CN value for the vehicle of interest is referred to as CNB. CNA should always be equal to CNB, and only one of the values, CNA or CNB, is necessary to use in the algorithm. Using the CN (CNA=CNB) allows system users to see the exact subspace that the car is in on a map or the like. The flow proceeds to determination step 866 in which the system user determines whether the subspaces in front and behind are both empty. In the case that there are no cars directly in front or behind the vehicle of interest T2, i.e. spots S1 and S3 are empty, the flow proceeds to step 867, and the user is prompted to type the subspace position of the vehicle of interest by manually counting, and the flow proceeds to step 868 and the vehicle is considered checked in. Alternatively, the flow proceeds directly to step 868.

Algorithm (array-indexing): In at least one embodiment, the algorithm uses an array data structure. The system creates an array of the maximum number of cars possible in the specific space, with each index as a datatype vehicle that stores the vehicle in the current index. In an embodiment, T0, T1, T2, T3, and T4 are the vehicles in spaces S0, S1, S2, S3, and S4. Note that the array is directionally front-to-back rather than back-to-front, just as the doubly-linked list is described above.

FIG. 8K is a flowchart of a method 870 of checking out a vehicle using an array data structure according to an embodiment. Similar to FIG. 8I, FIG. 8K assumes that there are vehicles, i.e., T0-T4, parked in subspaces, i.e., S0-S4, of a linear parking space. In a given example, T2 is non-linearly removed from subspace S2 and exits to a non-parking area. In step 871, the system creates an array sized corresponding to the maximum number of vehicles possible in the specific parking space with each index of the array as a datatype for the vehicle, which stores the vehicle in the current index as described above. As an example, assume vehicle T2 leaves via European parking, i.e. non-linear vehicle movement, out of space S2. The flow proceeds to step 872, wherein vehicle T2's QR code is scanned on the vehicle check-out page of the system, and T2 is checked out without the user first checking out the vehicles blocking T2 (T3 and T4). In this scenario, the system sets the element with index S2 to null in step 873. In step 874, the vehicle is removed non-linearly from the linear parking space subspace S2 and exits the parking area. The flow proceeds to step 875 and checkout is complete.

FIG. 8L is a flowchart of a method 880 of checking in a vehicle using an array data structure according to an embodiment. Similar to FIG. 8I, FIG. 8L assumes that there are vehicles, i.e., T0-T4, parked in subspaces, i.e., S0-S4, of a linear parking space. In a given example, T2 is non-linearly removed from subspace S2 and exits to a non-parking area. The flow begins at step 881 when vehicle T2 or any other vehicle enters/reparks/is forklifted in (check-in process). The flow proceeds to step 882 wherein the vehicle identifier, e.g., QR code, of the vehicle checking in is scanned, entered, or otherwise indicated and step 883, wherein the parking space identifier, e.g., QR code of the parking spot, is scanned, entered, or otherwise indicated. The flow proceeds to step 884, where a user determines if the subspace in front, i.e., subspace S3, is empty. If the determination is that the subspace is empty, the flow proceeds to step 885 and the user indicates via manipulation of the GUI that the subspace in front is empty. If the determination is that a vehicle is in the subspace in front, the flow proceeds to step 886 wherein the vehicle identifier, e.g., QR code, of the vehicle in front, i.e., in subspace S3, is scanned. The flow proceeds to step 887 wherein the system executes a query for the vehicle in front of the vehicle of interest, i.e., vehicle T3. The flow proceeds to step 888 wherein the system sets vehicle T2's index to vehicle T3's index+1. The flow proceeds to step 889 wherein vehicle T2 is inserted into the array at a new index. The flow proceeds to step 897 and the vehicle is checked in to the system.

Returning to step 885, the flow proceeds to step 890 for a determination by the user of whether the subspace behind, i.e., subspace S1, is empty. If the subspace behind is empty, the flow proceeds to step 891 wherein the user manipulates the GUI to indicate the subspace S1 is empty. The flow proceeds to step 892 and the user manually counts the subspace position of the vehicle of interest and enters the value on the check-in page of the GUI. The flow then proceeds to step 897 wherein the vehicle is checked in to the system.

Returning to determination step 890, if the subspace behind is not empty, i.e., there is a vehicle in the subspace behind the vehicle of interest, the flow proceeds to step 893. In step 893, the user scans the vehicle identifier, e.g., the QR code, of the vehicle behind, i.e., in spot S1. The flow proceeds to step 894 wherein the vehicle that is behind the vehicle of interest (T1) in the array is determined based on the system information, e.g., a database query. Then, in step 895, the index of the vehicle behind (T1)−1 is stored in the array as the position of the vehicle of interest, T2. Note that the position/value calculated from the front and back is always equal, and only one of such values is necessary for this assignment, similar to how CNA always equals CNB in the CN doubly-linked list operation. In step 896, vehicle T2 is inserted into the array at a new index. The flow then proceeds to step 897, and the vehicle is checked in to the system.

In at least one embodiment, the doubly-linked list implementation is more efficient when implemented with longer lists and if insertions need to occur. On the other hand, in another embodiment, when the maximum number of items that can fit into one spot is small (i.e., shorter lists), the array implementation is faster and more direct. The European-parking, or non-linear vehicle movement and parking cases, do not interfere with the previous regular parking cases as they are only induced when the vehicles are checked out out-of-order. Additionally, the variables vehicle-in-front and vehicle-behind are assigned manually via scanning as a determined type of parking situation, European parking, and thus cannot be any other case.

FIG. 9 is a flowchart of a method of mapping a parking lot, in accordance with an embodiment. The flow begins at step 901 wherein a user either arrives at a dealership parking lot or analyzes a parking lot layout via imagery, e.g., satellite, drone, or the like. The flow proceeds to step 902 wherein an accurate map of the parking lot is drawn or obtained and parking spaces are determined. The flow proceeds to step 903 wherein the user assesses parking scenarios on a parking lot of interest. The flow proceeds to step 904 wherein the user assigns parking space numbers and parking space identifiers, e.g., QR codes, per space/scenario. The flow proceeds to step 905 wherein the user assigns parking scenarios to each space. The flow proceeds to step 906 wherein parking space identifiers, e.g., QR codes, are assigned to parking spaces or numbers are painted on parking spaces. The flow completes at step 907.

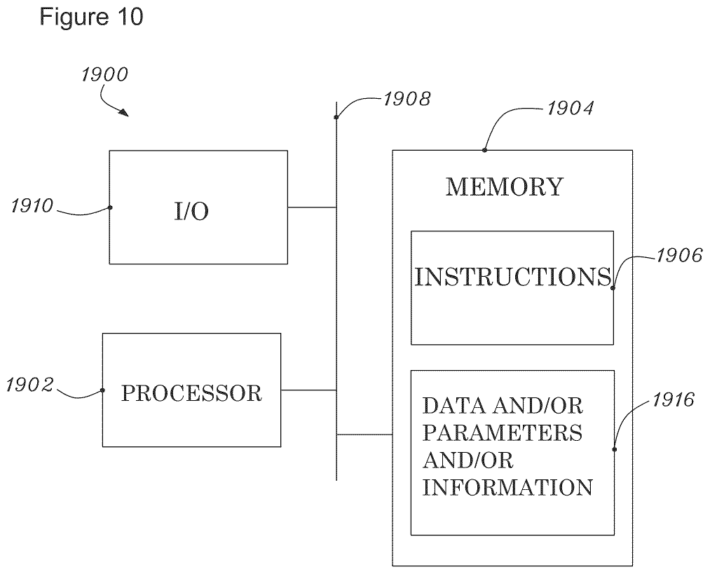

FIG. 10 depicts a high-level functional block diagram of a controller 1900 usable in conjunction with the embodiments herein. The controller 1900 includes input output 1910, processor 1902, and memory 1904. Input output 1910, processor 1902, and memory 1904 are connected by bus 1908. Memory 1904 includes instructions 1906 and other data 1916. Information in the form of electrical pulses is passed between the input output 1910, processor 1902, and memory 1904 to carry out the operation of controller 1900. Input out 1910 may be a display, touchscreen, mouse, keyboard, or a wired or wireless connection to another device. Instructions 1906 may include steps for carrying out functions or algorithms with processor 1902.

According to an embodiment, a system for tracking, retrieving, and storing vehicles in a vehicle dealership with quick-response (QR) codes is presented. A dealership lot is broken down into parking spaces where one or more vehicles may be parked. Dealership employees are tasked with finding and retrieving vehicles for customers, general inventory management, and maintenance. A parking space can be for one vehicle or multiple vehicles. A parking space may be any size or shape and may include markings or indicators in or near the space. The system includes at least one memory for storing information about each vehicle and instructions for operating the system.

Information corresponding to vehicles may be added to the memory by use of a handheld device. A system user may interact with other parts of the system by a handheld device or a central terminal. Information is collected about the vehicle in which a customer may be interested (e.g., make, model, year, color, or other features, or the like). The vehicle receives a QR code or other similar identification marking, e.g., a badge or the like. Information may be collected for each vehicle and stored in a database entry. The database entry is then managed by the system to represent the vehicle within the system. The entries, for example, may be viewed, modified, or deleted. Once a database entry for a vehicle is created or added to the system, further actions by a user or the system can be taken to manage vehicles in the parking lot.

One example of an action that can be taken to manage a database entry is to check a vehicle into a parking space. A system user can move the vehicle to a parking space where, by way of a handheld device, the system user scans a QR code or other identification marker at the parking space and on the vehicle. The information for both is transmitted from the handheld device to a database or other memory storage in the system. The system may include a database or other memory storage in one central location in the area of the parking lot, remote storage, including at a data center at any distance from the parking lot, or a combination thereof. A linking engine is used to link both data points in the memory.

A QR code or other identification badge may be physically attached to the vehicle. In the alternative, a native feature of the vehicle, such as the license plate or vehicle identification number (VIN), may serve as the identification badge without requiring anything to be attached to the vehicle. Additionally, a QR code or other identification badge may be affixed to a vehicle key or key fob. The key QR code may be the same as or different from the QR code or other similar identification badge on the vehicle.

After checking the vehicle into a parking space, a customer may request to test or purchase the vehicle from the vehicle dealership. This requires someone from the vehicle dealership to locate the vehicle and bring the vehicle to the customer's location. By pre-generating a map of the dealership and defining all available parking spaces, the vehicle dealership employee can be directed on the shortest possible path to the vehicle. The system user may scan the QR code or other similar identification badge on the vehicle and change the status. Options include, but are not limited to, test drive, maintenance, and customer viewing. If a vehicle is sold, the vehicle may be removed from the database after checking the vehicle out of a space. A system user may at any time move a checked-in vehicle from one space to another space.

The system may also indicate the vehicle of interest is blocked by other vehicles. The system may indicate all vehicles that need to be moved in order to retrieve a vehicle. The system may indicate where the keys are for all vehicles that need to be moved in order to retrieve a vehicle.

According to an embodiment, vehicles may be mass uploaded to establish a set of vehicles all at once in the system. This may be beneficial when a vehicle dealership first receives the system or on an ongoing basis as inventory is received in bulk.

According to an embodiment, the system may include different user accounts for different roles. For example, the system may include an administrator (admin) account, sales associate account, service account, or customer account. The admin account may include more permissions than a sales associate account. The admin account may be required to add/delete accounts for vehicle dealership employees, authorize a mass upload, or delete a vehicle from the system. Sales associate accounts or service accounts may perform basic functions including checking in a vehicle, scanning a QR code or other identification badge on the vehicle, and adding new vehicles to the system. Any division of permissions may be assigned between an admin account and an account with lower permissions. The division may include overlapping permissions.

Customer accounts may not require permission of the admin account to be created. The system may include a public-facing interface where a customer may access the vehicle inventory at a vehicle dealership. The customer may create an account, search the inventory, request a test drive of one or more vehicles, or purchase a vehicle. The public-facing interface may be accessed by the Internet or by terminals located at a dealership.

A system user generally refers to an employee of the dealership who is tasked with finding and moving vehicles. Customers can use the system with different permission levels.

One or more embodiments of the invention are generally described from the perspective of a salesperson retrieving a car from a dealership lot. It is envisioned that the invention is not limited to the vehicle salesperson dealership embodiment. For example, the solution presented herein can be implemented in any scenario where a person or user needs to retrieve an inventory item from a distributed space. In one or more embodiments, the distributed space includes rental car lots, warehouses, valets, parking garages, stores, shipyards or the like. The product retrieved may be any product including trucks, cars, vehicle parts, trailers, shipping containers, recreational vehicles, and merchandise generally such as phones, tablets, computers, appliances, furniture, or the like. The system may be fully automated and operated autonomously.

The various configurations included herein may be expanded to any size or number of vehicles and may be combined with other linear or complex parking spot configurations. Left, right, top, and bottom are terms of convenience and should not be interpreted as limiting to a particular orientation. The figures and descriptions may be practiced in other orientations including flipping vertically and horizontally without departing from the invention except where context requires otherwise. Similarly, lines depicted as straight may be at angles relative to other features and may include curved or rounded sections. The various embodiments and descriptions may be combined and altered in view of each other according to the teachings herein and the level of ordinary skill in the prior art.

According to embodiments herein, a method of arranging two or more vehicles in a parking space, the method comprising, scanning a first information tag attached to a first vehicle, wherein the scanned first information tag corresponds to a first unique identifier; transmitting the first unique identifier to a database; scanning a second information tag attached to a vehicle parking space, wherein the scanned second information tag corresponds to a second unique identifier; transmitting the second unique identifier to the database; scanning a third information tag attached to a second vehicle, wherein the scanned third information tag corresponds to a third unique identifier; transmitting the third unique identifier to the database; and arranging the second vehicle in the parking space so that the second vehicle blocks the first vehicle from leaving the parking space.

The embodiments further comprising, transmitting to the database a request to link the first unique identifier and the second unique identifier.

The embodiments further comprising, scanning a second information tag attached to a vehicle parking space a second time after the third information tag is scanned.

According to embodiments herein, a method of moving at least two parked vehicles based on information stored in a database, the information including parking order values for each vehicle corresponding to a time the vehicle entered a parking space, the method comprising, receiving an input for at least one of the at least two parked vehicles; transmitting to the database the input; wherein the at least one vehicle is blocked in the parking space by at least one other vehicle of the at least two parked vehicles; receiving from the database a list of vehicles comprising, the requested vehicle; and all the vehicles of the at least two parked vehicles that block the requested vehicle from exiting the parking space, wherein the list is based on the parking order values timestamps corresponding to each vehicle; displaying the list of vehicles; and moving each vehicle in the list of vehicles.

The embodiments wherein the list of vehicles is an ordered list of vehicles based on the timestamp correlating the time at which each vehicle entered the parking space.

The embodiments wherein moving each vehicle includes moving at least one vehicle out of the parking space.

The embodiments wherein each parking order value is a timestamp.

The embodiments wherein each parking order value is a spot number.

A system for moving at least two parked vehicles based on information stored in a database, the information including entries for each vehicle, timestamps parking order information for each vehicle, and at least one of the vehicles is blocked in a parking space by another vehicle of the at least two parked vehicles, the system comprising, a display; a memory comprising: an entry for each vehicle of the at least two parked vehicles; and a timestamp parking order value for each vehicle entry; a processor communicatively connected with the display and the memory; and a non-transitory computer readable medium comprising instructions and being communicatively connected with the processor which, when executed by the processor, cause the processor to: receive a request for a blocked vehicle, wherein the blocked vehicle is one of the at least two parked vehicles; receive a list of vehicles with a timestamp parking order value later in series than the timestamp parking order value of the blocked vehicle by querying the memory to return the entry and corresponding parking order value timestamp for each vehicle of the at least two parked vehicles; display the list of vehicles to a user using the display; and update at least one entry in the memory to reflect a change in position of at least one vehicle on the list of vehicles.

The embodiments wherein each parking order value is a timestamp.

The embodiments wherein each parking order value is a spot number.

1. A method of arranging two or more vehicles in a parking space, the method comprising,
scanning a first information tag attached to a first vehicle,
wherein the scanned first information tag corresponds to a first unique identifier;
transmitting the first unique identifier to a database;
scanning a second information tag attached to a vehicle parking space,
wherein the scanned second information tag corresponds to a second unique identifier;
transmitting the second unique identifier to the database;
scanning a third information tag attached to a second vehicle,
wherein the scanned third information tag corresponds to a third unique identifier;
transmitting the third unique identifier to the database; and
arranging the second vehicle in the parking space so that the second vehicle blocks the first vehicle from leaving the parking space.

2. The method of claim 1, further comprising, transmitting to the database a request to link the first unique identifier and the second unique identifier.

3. The method of claim 1, further comprising, scanning a second information tag attached to a vehicle parking space a second time after the third information tag is scanned.

4. The method of claim 1, further comprising transmitting a request for at least one of the at least two parked vehicles to the database.

5. The method of claim 4, further comprising receiving from the database a list of vehicles comprising:
the requested vehicle and all the vehicles of the at least two parked vehicles that block the requested vehicle from exiting the parking space.

6. The method of claim 5, wherein the at least one vehicle is blocked in the parking space by at least one other vehicle of the at least two parked vehicles.

7. The method of claim 5, wherein the list is based on the parking order values corresponding to each vehicle.

8. The method of claim 1, wherein the first unique identifier comprises a timestamp.

9. The method of claim 1, wherein the second unique identifier comprises a spot identifier.

10. The method of claim 1, wherein the second unique identifier comprises a timestamp.

11. The method of claim 1, wherein the third unique identifier comprises a timestamp.

12. A method of moving at least two parked vehicles based on information stored in a database, the information including parking order values for each vehicle corresponding to a time the vehicle entered a parking space, the method comprising,
receiving a request for at least one of the at least two parked vehicles;
transmitting to the database the request;
wherein the at least one vehicle is blocked in the parking space by at least one other vehicle of the at least two parked vehicles;
receiving from the database a list of vehicles comprising,
the requested vehicle; and
all the vehicles of the at least two parked vehicles that block the requested vehicle from exiting the parking space,
wherein the list is based on the parking order values corresponding to each vehicle;
displaying the list of vehicles; and
moving each vehicle in the list of vehicles.

13. The method of claim 12, wherein the list of vehicles is an ordered list of vehicles based on a timestamp correlating the time at which each vehicle entered the parking space.

14. The method of claim 12, wherein moving each vehicle includes moving at least one vehicle out of the parking space.

15. The method of claim 12, wherein each parking order value is a timestamp.

16. The method of claim 12, wherein each parking order value is a spot number.

17. A system for moving at least two parked vehicles based on information stored in a database, the information including entries for each vehicle, parking order information for each vehicle, and at least one of the vehicles is blocked in a parking space by another vehicle of the at least two parked vehicles, the system comprising,
a display;
a memory comprising:
an entry for each vehicle of the at least two parked vehicles; and
a parking order value for each vehicle entry;
a processor communicatively connected with the display and the memory; and
a non-transitory computer readable medium comprising instructions and being communicatively connected with the processor which, when executed by the processor, cause the processor to:
receive a request for a blocked vehicle,
wherein the blocked vehicle is one of the at least two parked vehicles;
receive a list of vehicles with a parking order value later in series than the parking order value of the blocked vehicle by querying the memory to return the entry and corresponding parking order value for each vehicle of the at least two parked vehicles;
display the list of vehicles to a user using the display to enable the user to move each vehicle in the list of vehicles; and
update at least one entry in the memory to reflect a change in position of at least one vehicle on the list of vehicles.

18. The system of claim 17, wherein each parking order value is a timestamp.

19. The system of claim 17, wherein each parking order value is a spot number.

20. The system of claim 17, wherein the list of vehicles is an ordered list of vehicles based on a timestamp correlating the time at which each vehicle entered the parking space.
